(19) United States
(12) Patent Application Publication
(10) Pub. No.: US 2026/0258674 A1
(43) Pub. Date: Sep. 3, 2026

(54) ACCESS CONTROL PLATFORM AND DIGITAL TWIN SECURITY SYSTEM FOR REAL-TIME FACILITY MONITORING

(71) Applicant: HavenLock Inc., Nashville, TN (US)

(72) Inventors: Alexander Michael Bertelli, Nashville, TN (US); Phil Leverette, Nashville, TN (US)

(73) Assignee: HavenLock Inc., Nashville, TN (US)

(21) Appl. No.: 19/655,402

(22) Filed: Apr. 22, 2026

Related U.S. Application Data
(63) Continuation-in-part of application No. 19/556,996, filed on Mar. 4, 2026.
Application No. 19/556,996 is a continuation of application No. 18/589,907, filed on Feb. 28, 2024, now Pat. No. 12,590,472.
(60) Provisional application No. 63/792,436, filed on Apr. 22, 2025.
(60) Provisional application No. 63/538,455, filed on Sep. 14, 2023.
(60) Provisional application No. 63/538,454, filed on Sep. 14, 2023.

(51) Int. Cl. E05B 63/14; E05B 47/00; G01S 17/06; G06T 19/00; G07C 9/00; G07C 9/28; G08B 25/10

(52) U.S. Cl. CPC E05B 63/14; E05B 47/0012; G01S 17/06; G06T 19/00; G07C 9/00571; G07C 9/28; G08B 25/10; E05B 2047/0067; G06T 2200/24

(57) ABSTRACT

A system for generating a digital twin environment of a physical facility enabling real-time remote visualization and monitoring of physical security conditions includes a server configured to receive spatial data representing a physical layout of the physical facility and generate an initial three-dimensional spatial model based on the spatial data. A plurality of cameras distributed throughout the physical facility capture real-time video data of respective areas. A digital twin interface receives the initial three-dimensional spatial model, receives the real-time video data from the plurality of cameras, stitches the real-time video data together, and overlays the stitched real-time video data onto the three-dimensional spatial model to generate an interactive digital twin that mirrors real-time activity within the physical facility. A user device displays the interactive digital twin such that a user may virtually navigate through the physical facility in real-time.

### CROSS-REFERENCE TO RELATED APPLICATIONS

This application claims priority to U.S. Provisional Patent Application No. 63/792,436, titled “Access Control Platform with Real-Time Digital Twin Security with Blockchain Monetization”, filed April 22, 2025 and is a Continuation-In-Part of U.S. Application No. 19/556,996, titled “Security System and Devices”, filed March 4, 2026, which is a continuation to U.S. Non-Provisional Patent Application No. 18/589,907, titled “Security System and Devices”, filed February 28, 2024, and claims benefit of U.S. Provisional Patent Application No. 63/538,454, titled “Real-Time Monitoring System and Communications Network”, dated September 14, 2023, and U.S. Provisional Patent Application No. 63/538,455, titled “Locking System for Resisting Movement of an Object”, dated September 14, 2023, which are hereby incorporated by reference in full.

### FIELD OF INVENTION

The present disclosure relates to access control and facility security systems, and more particularly to a digital twin platform that integrates smart lock devices, real-time video feeds, and sensor data to generate an interactive three-dimensional visualization of a physical facility for security monitoring and emergency response applications.

### BACKGROUND

Facility security and access control have become progressively more relevant considerations for organizations managing schools, hospitals, government buildings, and other sensitive infrastructure. Traditional access control systems typically provide basic entry authentication and log management capabilities, but may lack comprehensive situational awareness or real-time operational insight into facility conditions.

Crisis situations may arise in which a facility may be locked down to ensure the safety of those inside. Coordinating a lockdown across a facility that includes multiple doors, rooms, and corridors can present challenges. Traditional lock mechanisms, such as deadbolt locks, are used to prevent or restrict access to interior spaces. While multiple locking devices may be installed throughout a facility, each locking device may be operated independently. Thus, in a crisis situation, each locking device may be activated separately, which can consume valuable time.

When a crisis situation is recognized, lockdown instructions are often relayed throughout the facility. At times, it may be difficult to alert the entire facility in a quick, safe, and efficient manner. Once an alert is relayed, individuals may be relied upon to individually lock doors. Relaying information and waiting for individuals to act can take precious seconds, if not minutes, that may be valuable in a crisis situation.

First responders who respond to crisis situations often enter locked-down facilities to secure the interior and address any remaining threats. First responders may enter a facility with limited knowledge regarding the nature of a threat or its location. Moreover, first responders may not be familiar with the layout of the facility, further adding to the complexity of the situation. First responders may proceed door-to-door securing rooms within the facility and learning the facility layout as they proceed. With individual rooms being locked down, it can be difficult for first responders to identify which rooms are secure and which may require attention. This process takes time and may place the lives of first responders at risk.

Digital twin technologies, which create virtual replicas of physical systems that are continuously updated with real-world data, have been deployed in various industrial and engineering contexts. Such technologies may allow for real-time monitoring, simulation, analysis, and optimization of physical environments. However, substantial integration of digital twin technologies into physical security workflows has been limited.

Similarly, blockchain solutions offer potential benefits for ensuring trust, transparency, and data integrity, but have seen limited practical deployment in access control or compliance auditing applications. Legacy access control systems may rely on centralized databases and siloed infrastructure, which can present challenges for scalability and auditing, particularly in regulated environments.

Therefore, improved systems and methods for facility monitoring and security are desired.

### SUMMARY

This summary is provided to introduce a selection of concepts in a simplified form that are further described below in the detailed description. This summary is not intended to identify notable features or core features of the claimed subject matter, nor is it intended to be used as an aid in determining the scope of the claimed subject matter.

According to an aspect of the present disclosure, a system for generating a digital twin environment of a physical facility is provided. The system includes a server configured to receive spatial data representing a physical layout of the physical facility and generate an initial three-dimensional spatial model of the physical facility based on the spatial data. The system includes a plurality of cameras distributed throughout the physical facility, each camera configured to capture real-time video data and audio data of a respective area within the physical facility. The system includes a digital twin interface configured to receive the initial three-dimensional spatial model, receive the real-time video data from the plurality of cameras, stitch the real-time video data from the plurality of cameras together, and overlay the stitched real-time video data onto the three-dimensional spatial model to generate an interactive digital twin of the physical facility that mirrors real-time activity within the physical facility. The system includes a user device configured to display the interactive digital twin such that a user may virtually navigate through the physical facility in real-time.

According to other aspects of the present disclosure, the system may include one or more of the following features. The digital twin interface may be accessible via at least one of an augmented reality device, a virtual reality device, a mobile device, or a desktop computer. The system may further include a mobile scanning device configured to scan and map the physical facility to generate the spatial data. The plurality of cameras may be integrated within smart lock devices positioned at secured portals throughout the physical facility. Each smart lock device may include a camera configured to capture video data of at least one of an interior area or an exterior area adjacent to a corresponding secured portal, one or more sensors configured to capture sensor data, and a locking device configured to selectively restrict movement of a door associated with the corresponding secured portal. The one or more sensors may include at least one of a motion sensor, a tamper sensor, a smoke sensor, a temperature sensor, an occupancy sensor, or a light detection and ranging sensor. The digital twin interface may be further configured to overlay sensor event data onto the interactive digital twin, the sensor event data including at least one of unauthorized entry detection data, fire detection data, or access status data. The digital twin interface may be further configured to enable historical replay of events within the interactive digital twin. The system may further include an edge AI module configured to perform object detection and anomaly detection using artificial intelligence on the real-time video data. The edge AI module may be configured to detect security anomalies including at least one of forced entry, tailgating, unauthorized loitering, or door propping. The system may further include a blockchain integration module configured to immutably log access events and sensor detections to a distributed ledger.

According to another aspect of the present disclosure, a method for generating a digital twin environment of a physical facility is provided. The method includes receiving spatial data representing a physical layout of the physical facility. The method includes generating an initial three-dimensional spatial model of the physical facility based on the spatial data. The method includes installing a plurality of cameras at locations distributed throughout the physical facility. The method includes calibrating positions of the plurality of cameras within the three-dimensional spatial model. The method includes capturing real-time video data from the plurality of cameras. The method includes stitching the real-time video data from the plurality of cameras together. The method includes overlaying the stitched real-time video data onto the three-dimensional spatial model to generate an interactive digital twin of the physical facility. The method includes enabling real-time virtual navigation through the interactive digital twin via a user interface.

According to other aspects of the present disclosure, the method may include one or more of the following features. The plurality of cameras may be integrated within smart lock devices positioned at secured portals throughout the physical facility. The method may further include overlaying sensor data onto the interactive digital twin, the sensor data including at least one of occupancy data, environmental condition data, or access event data. The method may further include detecting an anomaly within the physical facility based on the real-time video data using artificial intelligence and generating an alert in response to detecting the anomaly. The anomaly may include at least one of forced entry, tailgating, unauthorized loitering, or door propping. The method may further include logging access events to a distributed ledger via a blockchain integration module. Enabling real-time virtual navigation may include displaying the interactive digital twin on at least one of an augmented reality device, a virtual reality device, a mobile device, or a desktop computer. Receiving the spatial data may include scanning and mapping the physical facility using a mobile scanning device.

According to another aspect of the present disclosure, a digital twin system for real-time facility monitoring is provided. The system includes a plurality of smart lock devices distributed at secured portals throughout a physical facility, each smart lock device comprising a camera configured to capture real-time video data and audio data and one or more sensors configured to capture sensor data. The system includes a server linked to the plurality of smart lock devices via a communications network, the server configured to receive the real-time video data and the sensor data from the plurality of smart lock devices, generate a three-dimensional spatial model of the physical facility based at least in part on the real-time video data, and stitch the real-time video data from the plurality of smart lock devices into the three-dimensional spatial model to generate an interactive digital twin. The system includes a digital twin interface configured to display the interactive digital twin on a user device, wherein the interactive digital twin enables a user to virtually navigate through the physical facility in real-time.

According to other aspects of the present disclosure, the digital twin system may include one or more of the following features. The digital twin interface may be further configured to overlay the sensor data onto the interactive digital twin to display real-time sensor events within the physical facility. The server may employ artificial intelligence and machine learning to detect a threat within the physical facility based on the real-time video data and the sensor data, and the system may be configured to trigger a locking function to simultaneously lock a plurality of locking devices associated with the plurality of smart lock devices in response to detecting the threat.

The foregoing general description of the illustrative embodiments and the following detailed description thereof are example aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a security system architecture, according to aspects of the present disclosure.

FIG. 2 illustrates an enhanced block diagram of a security system with digital twin and blockchain integration, according to aspects of the present disclosure.

FIG. 3A illustrates a perspective view of a smart lock device installed on a door assembly in a first embodiment, according to aspects of the present disclosure.

FIG. 3B illustrates another perspective view of the smart lock device of FIG. 3A, according to aspects of the present disclosure.

FIG. 4 illustrates a side cross-sectional view of a smart lock device in a second embodiment, according to aspects of the present disclosure.

FIG. 5A illustrates a perspective view of a smart lock device in a third embodiment, according to aspects of the present disclosure.

FIG. 5B illustrates another perspective view of the smart lock device of FIG. 5A, according to aspects of the present disclosure.

FIG. 6A illustrates a perspective view of internal components of a smart lock device, according to aspects of the present disclosure.

FIG. 6B illustrates a cutaway perspective view of internal components of a smart lock device, according to aspects of the present disclosure.

FIG. 7A illustrates a two-dimensional view of a sensor activated notification system displaying a building layout, according to aspects of the present disclosure.

FIG. 7B illustrates another two-dimensional view of the sensor activated notification system of FIG. 7A, according to aspects of the present disclosure.

FIG. 7C illustrates another two-dimensional view of the sensor activated notification system of FIG. 7A, according to aspects of the present disclosure.

FIG. 7D illustrates a two-dimensional view of the sensor activated notification system displaying first responder deployment, according to aspects of the present disclosure.

FIG. 7E illustrates another two-dimensional view of the sensor activated notification system of FIG. 7D, according to aspects of the present disclosure.

FIG. 7F illustrates another two-dimensional view of the sensor activated notification system of FIG. 7D, according to aspects of the present disclosure.

FIG. 7G illustrates a two-dimensional view of the sensor activated notification system displaying interior camera functionality, according to aspects of the present disclosure.

FIG. 8A illustrates a perspective view within a digital twin environment showing a door assembly, according to aspects of the present disclosure.

FIG. 8B illustrates another perspective view within the digital twin environment of FIG. 8A, according to aspects of the present disclosure.

FIG. 8C illustrates a perspective view of a digital twin intruder detection system displaying an interior three-dimensional model, according to aspects of the present disclosure.

FIG. 8D illustrates another perspective view of the digital twin intruder detection system of FIG. 8C, according to aspects of the present disclosure.

FIG. 8E illustrates another perspective view of the digital twin intruder detection system of FIG. 8C, according to aspects of the present disclosure.

FIG. 8F illustrates another perspective view of the digital twin intruder detection system of FIG. 8C, according to aspects of the present disclosure.

FIG. 8G illustrates a perspective view of the digital twin intruder detection system displaying intruder identification, according to aspects of the present disclosure.

FIG. 9A illustrates a camera processing pipeline for cameras with depth sensing capability, according to aspects of the present disclosure.

FIG. 9B illustrates a camera processing pipeline for cameras without dedicated depth sensors, according to aspects of the present disclosure.

FIG. 10A illustrates a three-dimensional digital twin view of a multi-camera visualization system, according to aspects of the present disclosure.

FIG. 10B illustrates a daytime point cloud reconstruction within a three-dimensional digital twin view, according to aspects of the present disclosure.

FIG. 10C illustrates a nighttime point cloud reconstruction within the three-dimensional digital twin view of FIG. 10B, according to aspects of the present disclosure.

FIG. 11 illustrates a flowchart of a method for generating a digital twin environment of a physical facility, according to aspects of the present disclosure.

FIG. 12 illustrates a system diagram of a blockchain integration system, according to aspects of the present disclosure.

FIG. 13 illustrates a flowchart of a method for tokenized access control, according to aspects of the present disclosure.

FIG. 14 illustrates a sequence diagram of a method for immutable audit logging, according to aspects of the present disclosure.

FIG. 15 illustrates a flowchart of a method for edge AI anomaly detection, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Aspects of the present disclosure relate to a system for generating a digital twin environment of a physical facility. The system may include a server configured to receive spatial data representing a physical layout of the physical facility and generate an initial three-dimensional spatial model of the physical facility based on the spatial data. In some aspects, the system may include a mobile scanning device configured to scan and map the physical facility to generate the spatial data. The system may include a plurality of cameras distributed throughout the physical facility, each camera configured to capture real-time video data and audio data of a respective area within the physical facility. In some aspects, the plurality of cameras may be integrated within smart lock devices positioned at secured portals throughout the physical facility. Each smart lock device may comprise a camera configured to capture video data of at least one of an interior area or an exterior area adjacent to a corresponding secured portal, one or more sensors configured to capture sensor data, and a locking device configured to selectively restrict movement of a door associated with the corresponding secured portal. The system may include a digital twin interface configured to receive the initial three-dimensional spatial model, receive the real-time video data from the plurality of cameras, stitch the real-time video data from the plurality of cameras together, and overlay the stitched real-time video data onto the three-dimensional spatial model to generate an interactive digital twin of the physical facility that mirrors real-time activity within the physical facility. The system may include a user device configured to display the interactive digital twin such that a user may virtually navigate through the physical facility in real-time.

Aspects of the present disclosure also relate to a method for generating a digital twin environment of a physical facility. The method may include receiving spatial data representing a physical layout of the physical facility. In some aspects, receiving the spatial data may comprise scanning and mapping the physical facility using a mobile scanning device. The method may include generating an initial three-dimensional spatial model of the physical facility based on the spatial data. The method may include installing a plurality of cameras at locations distributed throughout the physical facility. The method may include calibrating positions of the plurality of cameras within the three-dimensional spatial model. The method may include capturing real-time video data from the plurality of cameras and stitching the real-time video data from the plurality of cameras together. The method may include overlaying the stitched real-time video data onto the three-dimensional spatial model to generate an interactive digital twin of the physical facility. The method may include enabling real-time virtual navigation through the interactive digital twin via a user interface. In some aspects, the method may include detecting an anomaly within the physical facility based on the real-time video data using artificial intelligence and generating an alert in response to detecting the anomaly. In some aspects, the method may include overlaying sensor data onto the interactive digital twin. In some aspects, the method may include logging access events to a distributed ledger via a blockchain integration module.

Conventional security systems may present technical challenges related to data integration, visualization latency, and situational awareness. Traditional access control systems may collect data from multiple sensors and cameras, but the data may be siloed across different subsystems, requiring security personnel to monitor multiple separate interfaces. This fragmented approach may result in delayed threat detection and response times, as security personnel must mentally correlate information from disparate sources.

The present disclosure addresses these technical challenges by providing a unified digital twin architecture that integrates real-time video feeds from distributed cameras with a three-dimensional spatial model of a physical facility. The technical improvement achieved by the disclosed system includes reduced latency in threat visualization by stitching multiple camera feeds directly onto a pre-generated spatial model, eliminating the need for security personnel to switch between separate camera views and floor plan displays. The stitching process performed by the digital twin interface represents a specific technical implementation that transforms raw video streams from multiple cameras into a cohesive, navigable three-dimensional environment.

The disclosed system further provides a technical improvement to edge computing architectures by performing anomaly detection locally at smart lock devices using the edge AI module, rather than transmitting all video data to a central server for processing. This edge-based processing reduces network bandwidth requirements and decreases detection-to-alert latency compared to cloud-based processing approaches. The multi-sensor fusion module provides an additional technical improvement by correlating data from multiple sensor types, including force detectors, door position sensors, motion sensors, and cameras, to reduce false positive rates in anomaly detection compared to single-sensor approaches.

The blockchain integration module provides a technical improvement to audit trail integrity by recording access events and sensor detections to a distributed ledger using cryptographic techniques. The zero-knowledge proof engine enables verification of compliance with regulatory conditions without exposing underlying sensitive data, representing a technical solution to the competing conditions of audit transparency and data privacy.

The camera processing system provides a technical improvement to three-dimensional reconstruction by implementing a pipeline that performs lens distortion correction, point cloud extraction, and point cloud stitching to generate unified three-dimensional representations from distributed camera feeds. The use of Gaussian splat rasterization for first-person perspective rendering represents a specific technical implementation that enables real-time navigation through the digital twin environment with reduced computational overhead compared to traditional mesh-based rendering approaches.

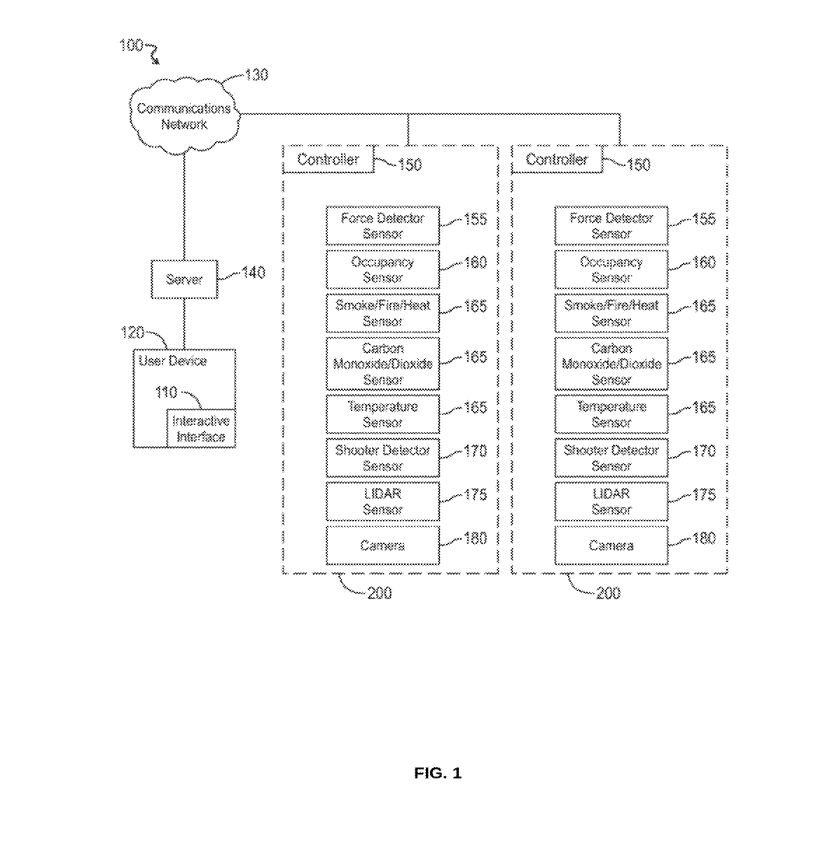

FIG. 1 illustrates a block diagram of a security system 100 according to aspects of the present disclosure. The security system 100 may be configured to operate in association with a physical facility. The physical facility may include a plurality of rooms with corresponding doors providing access thereto. The security system 100 may enable real-time remote visualization and monitoring of physical security conditions within the physical facility.

The security system 100 may include a communications network 130. The communications network 130 may be associated with a setup location or central hub of the security system 100. Each of the devices associated with the security system 100 may be linked to the communications network 130. The communications network 130 may enable communication between the various components of the security system 100 via wired or wireless connections.

The security system 100 may include a server 140 linked to the communications network 130. The server 140 may be configured to receive spatial data representing a physical layout of the physical facility and generate an initial three-dimensional spatial model of the physical facility based on the spatial data. The server 140 may be configured to generate an interactive interface 110 for controlling and monitoring a plurality of devices associated with the security system 100. The server 140 may be housed within the physical facility or remotely.

The security system 100 may include a user device 120. The user device 120 may be a smart phone, a smart television, a computer, or the like. The user device 120 may be coupled to the communications network 130 via a wired or wireless connection. The user device 120 may display the interactive interface 110. A software application may be associated with the security system 100. The security system 100 may allow a user to restrict access to the interactive interface 110 and the communications network 130 of the security system 100 to specific users. In some aspects, access to the security system 100 may be password protected.

The security system 100 may include one or more controllers 150. Each controller 150 may be a programmable logic controller (PLC) or similar device. The controller 150 may be housed within each of the plurality of devices associated with the security system 100. The security system 100 may also include one or more controllers 150 that are independent of the plurality of devices. The controller 150 may be associated with and coupled to the communications network 130 of the security system 100. The controller 150 may be configured to receive input signals from various sensors. The controller 150 may generate control signals for controlling various operations of the security system 100 and specific devices.

The security system 100 may include a plurality of cameras distributed throughout the physical facility. Each camera may be configured to capture real-time video data and audio data of a respective area within the physical facility. In some aspects, the plurality of cameras may be installed at locations distributed throughout the physical facility corresponding to secured portals. The cameras may generate output signals representing images and audio of a camera viewing area. The camera viewing area may include an interior of a room and an exterior area adjacent to a secured portal.

The security system 100 may include one or more sensors linked to the communications network 130. Each sensor may be configured to detect at least an event and generate an output signal representing the detected event. The one or more sensors may include a force detector sensor 155. The force detector sensor 155 may be configured to detect physical impact on a secured portal and generate output signals representing the detected impact.

The one or more sensors may include an occupancy sensor 160. The occupancy sensor 160 may be configured to detect the presence of one or more persons within a proximity of the occupancy sensor 160 and may generate at least a signal corresponding thereto. One or more output signals of the occupancy sensor 160 may be provided to the controller 150 and to the communications network 130. The controller 150 and the communications network 130 may receive the output signals, determine a number of people in a room, and generate output signals representing an occupancy number.

The one or more sensors may include a smoke/fire/heat sensor 165. The smoke/fire/heat sensor 165 may be configured to detect smoke, fire, heat, carbon monoxide, carbon dioxide, radon, air pressure, humidity, temperature, air quality, and other environmental conditions. The smoke/fire/heat sensor 165 may generate at least a signal corresponding to a detected environmental condition. One or more output signals of the smoke/fire/heat sensor 165 may be provided to the controller 150 and to the communications network 130. The controller 150 and the communications network 130 may receive the output signals and output an alert to at least an associated user device 120 and emergency services.

The one or more sensors may include a shooter detector sensor 170. The shooter detector sensor 170 may comprise one or more of a sound sensor, a light flash sensor, or the like. The shooter detector sensor 170 may be configured to detect the presence of a shooter via detection of a visual muzzle flash or audible gunshot sound and may generate at least a signal corresponding thereto. One or more output signals of the shooter detector sensor 170 may be provided to the controller 150 and to the communications network 130. The controller 150 may lock a locking device 200 upon receiving the output signals from the shooter detector sensor 170. The controller 150 may communicate with all other communicatively linked locking devices 200 of the security system 100 via the communications network 130 and trigger a locking function to simultaneously lock all or a select portion of rooms within a given facility.

The one or more sensors may include a light detection and ranging (LIDAR) sensor 175. The LIDAR sensor 175 may be configured to detect distances and positions of objects within a field of view of the LIDAR sensor 175. The LIDAR sensor 175 may generate output signals representing a position of an object relative to the LIDAR sensor 175. The LIDAR sensor 175 may include a light source and an optical receiver. The light source may include a laser capable of emitting a beam of light having a particular operating wavelength. The LIDAR sensor 175 may generate output signals on the communications network 130 that are received by the interactive interface 110. At least the output signals from the LIDAR sensor 175 may be used by the interactive interface 110 to build a virtual model of an interior of a facility. Output signals from multiple LIDAR sensors 175 placed throughout a facility may be meshed together to create a comprehensive virtual model of the interior of the facility. The LIDAR sensor 175 may also track the movement of objects, for example the movement of people, within a facility.

The security system 100 may include a plurality of locking devices 200 linked to the communications network 130. Each locking device 200 may be configured to selectively restrict movement of a door. Each locking device 200 may include an actuator and a controller 150 associated therewith. Each controller 150 may be configured to receive the output signal from the one or more sensors, process the received output signal to determine an actuator command, provide the actuator command to the actuator of the locking device 200, and produce an actuator output based on the actuator command. The actuator output may be operable to manipulate the locking device 200 between a locked configuration and an unlocked configuration. In the locked configuration, the locking device 200 may resist movement of the door.

In some aspects, each locking device 200 may include a chassis. The chassis may be modular such that the chassis may receive a variety of components in various configurations. Components associated with the chassis may be interchanged based on a desired application. The components may also be replaced when the components become outdated or reach an end of useful life without having to replace the chassis. The modular nature of the chassis may enable the locking device 200 to adapt to future desired applications.

The security system 100 may include a panic button and an egress button. The panic button and the egress button may be connected to the locking device 200 via a wired or wireless connection. In some aspects, the panic button and the egress button may be mounted adjacent to a door assembly. In other aspects, the panic button may be located distal to the door assembly, for example adjacent to a teacher's desk in a school setting. The panic button may be configured to place the locking device 200 in the locked configuration when the panic button is pressed. The egress button may be configured to place the locking device 200 in the unlocked configuration when the egress button is pressed. The panic button and the egress button may be associated with a single locking device 200 or may be associated with a plurality of locking devices 200.

The security system 100 may provide an access process for first responders, for example police officers, who may not be one of the specific users given access to the interactive interface 110 and the communications network 130 of the security system 100. The access process may be a passcode, a password, a user override, or the like. When first responders arrive to a facility employing the security system 100, the access process may allow first responders to utilize and manipulate aspects of the security system 100 to neutralize an existing threat and protect those inside the facility.

The plurality of devices associated with the security system 100 may include any and all smart devices or otherwise that are capable or may be enabled to connect to and be monitored and controlled through the communications network 130. The plurality of devices, when coupled to the server 140, may enable a user to monitor the interior and exterior of a facility in real-time and control various devices associated therewith.

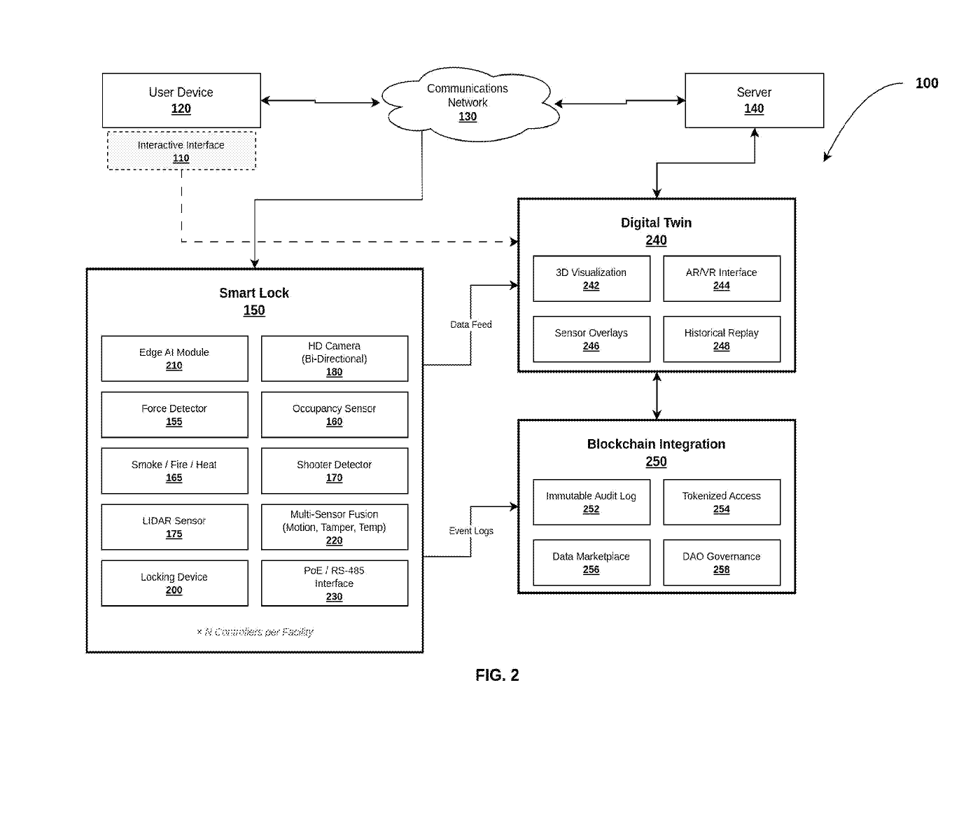

FIG. 2 illustrates an enhanced block diagram of the security system 100 incorporating digital twin and blockchain integration layers according to aspects of the present disclosure. As described above, the security system 100 may include the user device 120 with the interactive interface 110, the communications network 130, the server 140, and one or more controllers 150.

The controller 150 may include a camera 180 configured to capture real-time video data. The camera 180 may be a fire-rated through-bolt high-definition camera configured to capture video data and audio data of at least one of an interior area or an exterior area adjacent to a corresponding secured portal. The camera 180 may be bidirectional, capturing both interior and exterior visuals. The camera 180 may also capture audio data via an integrated microphone. The camera 180 may feed real-time event data to other components of the security system 100.

The controller 150 may include an edge AI module 210. The edge AI module 210 may be configured to perform object detection and anomaly detection using artificial intelligence on the real-time video data. The edge AI module 210 may perform object detection and person detection in addition to anomaly detection at the edge, without transmitting all video data to a remote server for processing. The edge AI module 210 may be configured to detect security anomalies including at least one of forced entry, tailgating, unauthorized loitering, or door propping.

The controller 150 may include a multi-sensor fusion module 220. The multi-sensor fusion module 220 may be configured to integrate data from motion sensors, tamper sensors, smoke sensors, and temperature sensors to provide comprehensive environmental monitoring. The multi-sensor fusion module 220 may combine data from multiple sensor types to reduce false positive rates in anomaly detection compared to single-sensor approaches.

The controller 150 may include a Power-over-Ethernet (PoE)/RS-485 interface 230. The PoE/RS-485 interface 230 may be configured to connect to building access control systems using Mercury protocol in addition to RS-485 and Power-over-Ethernet communication protocols. The PoE/RS-485 interface 230 may enable the controller 150 to receive both power and data through a single network connection.

The controller 150 may be configured for integration into smart building platforms. The PoE/RS-485 interface 230 may enable direct integration into existing building access control systems and building management systems. The controller 150 may communicate with building automation systems to coordinate security operations with other building functions including HVAC, lighting, and elevator control. The integration capability may enable the security system 100 to operate as a component within a broader smart building ecosystem.

The security system 100 may include a digital twin interface 240. The digital twin interface 240 may be configured to receive an initial three-dimensional spatial model of the physical facility. The digital twin interface 240 may be configured to receive the real-time video data from the plurality of cameras 180. The digital twin interface 240 may be configured to stitch the real-time video data from the plurality of cameras 180 together. The digital twin interface 240 may be configured to overlay the stitched real-time video data onto the three-dimensional spatial model to generate an interactive digital twin of the physical facility that mirrors real-time activity within the physical facility. The user device 120 may be configured to display the interactive digital twin such that a user may virtually navigate through the physical facility in real-time.

The digital twin interface 240 may include a 3D visualization module 242. The 3D visualization module 242 may be configured to render the three-dimensional spatial model and the stitched real-time video data as a navigable three-dimensional environment.

The digital twin interface 240 may include an AR/VR interface 244. The AR/VR interface 244 may enable the digital twin interface 240 to be accessible via at least one of an augmented reality device, a virtual reality device, a mobile device, or a desktop computer.

The digital twin interface 240 may include a sensor overlay module 246. The sensor overlay module 246 may be configured to overlay sensor event data onto the interactive digital twin. The sensor event data may include at least one of intrusion detection data, fire detection data, or access status data.

The digital twin interface 240 may include a historical replay module 248. The historical replay module 248 may be configured to enable historical replay of events within the interactive digital twin for reviewing past incidents and events within the facility. The digital twin interface 240 may include emergency planning and training simulation capabilities for disaster preparedness. The digital twin interface 240 may support multi-user access with role-based access control to manage different permission levels for various stakeholders.

The security system 100 may include a blockchain integration module 250. The blockchain integration module 250 may be configured to immutably log access events and sensor detections to a distributed ledger. The digital twin interface 240 may communicate bidirectionally with the blockchain integration module 250.

The blockchain integration module 250 may include an immutable audit log 252. The immutable audit log 252 may be configured to record access events and sensor detections as immutable records on the distributed ledger. The immutable audit log 252 may use cryptographic techniques to provide audit trail integrity.

The blockchain integration module 250 may include a tokenized access control 254. The tokenized access control 254 may be configured to manage access permissions using cryptographic tokens. Each cryptographic token may represent time-based or role-based access rights to one or more secured portals. The tokenized access control 254 may issue non-fungible tokens or utility tokens representing access permissions.

The blockchain integration module 250 may include a data marketplace 256. The data marketplace 256 may be configured to enable monetization of anonymized sensor data, behavioral data, or AI behavior patterns derived from digital twins through a decentralized marketplace. In some aspects, the data marketplace 256 may tokenize ownership of AI training data or anonymized analytics from digital twin environments. The data marketplace 256 may use smart contracts to enforce usage rights and royalties for data access. Smart contract royalties may enforce usage rights for data accessed through the data marketplace 256. In some aspects, researchers, facility operators, insurers, or defense contractors may purchase secure access to specific data streams through the data marketplace 256. The data marketplace 256 may provide royalties for reused models or predictive maintenance packages.

The blockchain integration module 250 may include a DAO governance module 258. The DAO governance module 258 may be configured to allow stakeholders to vote on platform development priorities or alarm response protocols. The DAO governance module 258 may issue and manage governance tokens, wherein each governance token represents voting rights within a decentralized governance system. The DAO governance module 258 may be configured to conduct token sales to raise funds for platform development, wherein proceeds from the token sales are managed according to governance proposals approved by governance token holders.

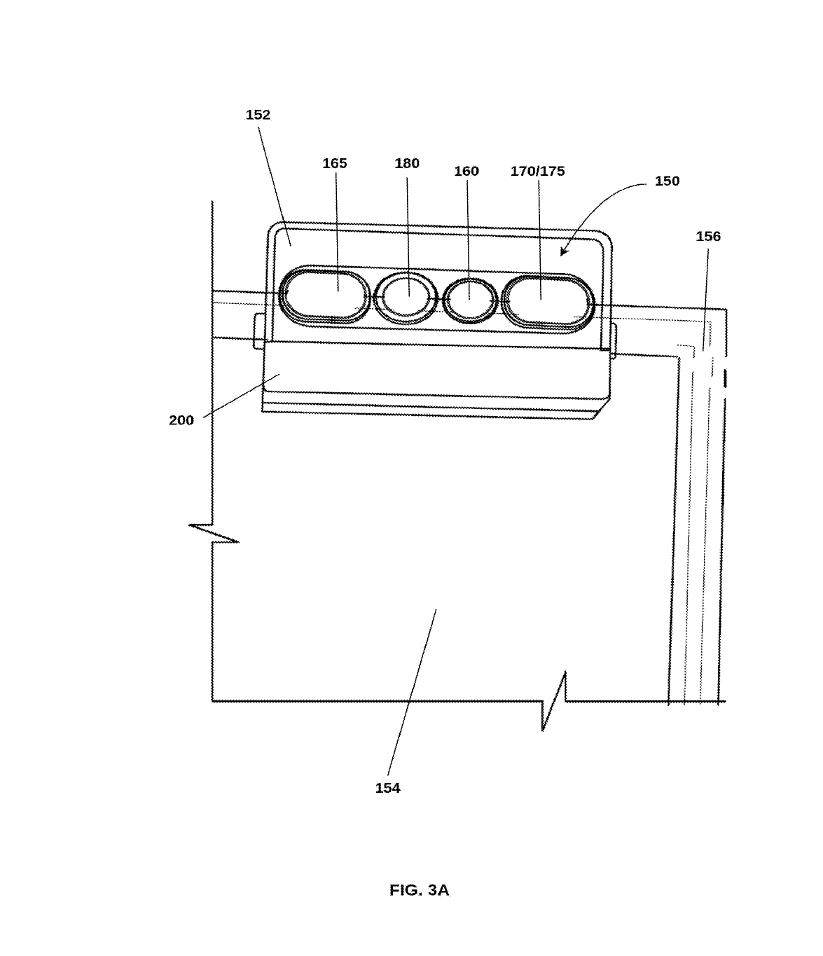

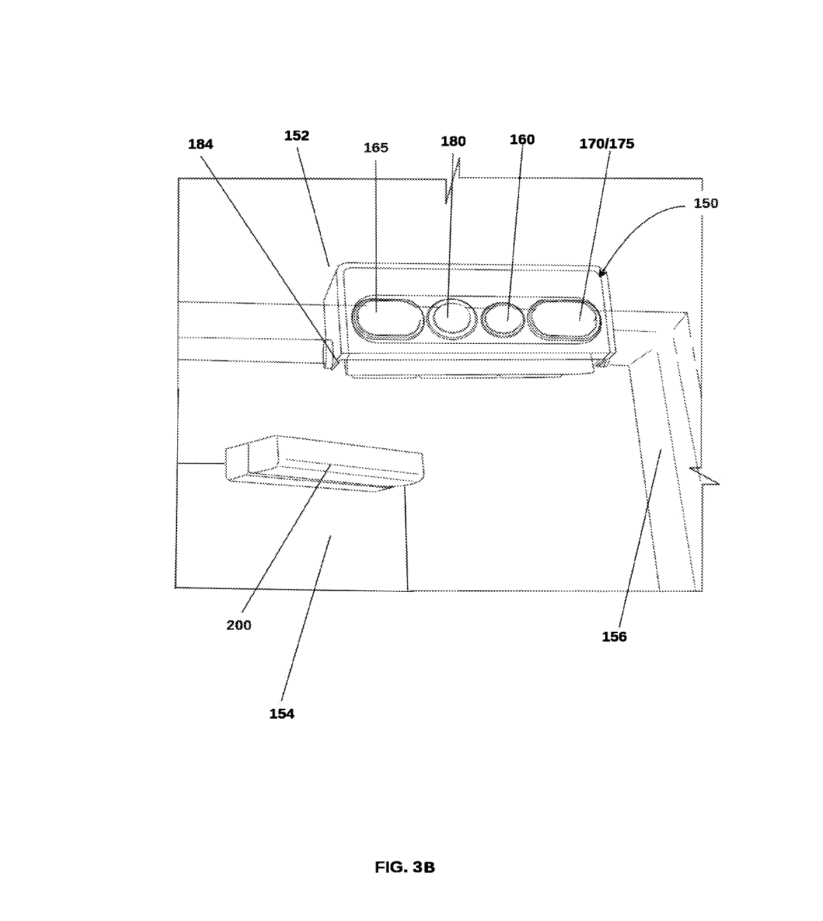

FIG. 3A and FIG. 3B illustrate perspective views of a smart lock device installed on a door assembly in a first embodiment according to aspects of the present disclosure. As described above, the plurality of cameras 180 may be integrated within smart lock devices positioned at secured portals throughout the physical facility. The smart lock devices may comprise commercial-grade door hardware configured for installation in commercial, institutional, and industrial facilities.

The smart lock device may include a housing 152 mounted at an upper portion of a door 154 adjacent to a door frame 156. The housing 152 may contain the controller 150 and associated sensor components. The housing 152 may comprise a fire-rated enclosure that provides fire protection for internal components of the smart lock device while maintaining structural integrity during fire events.

The smart lock device may include a camera 180 integrated within the housing 152. The camera 180 may include a camera lens array visible on a front panel of the housing 152. The camera lens array may include an oval-shaped lens aperture on a left side, two circular lens apertures in a center portion, and an oval-shaped lens aperture on a right side. The camera 180 may be a through-bolt high-definition camera configured to capture video data and audio data of at least one of an interior area or an exterior area adjacent to a corresponding secured portal. The camera 180 may capture both interior and exterior visuals and audio around the secured portal.

The smart lock device may include one or more sensors configured to capture sensor data. The housing 152 may contain an occupancy sensor 160 configured to detect the presence of occupants within a room or area adjacent to the secured portal. The housing 152 may contain a smoke/fire/heat sensor 165 configured to detect smoke, fire, heat, or other environmental conditions. The housing 152 may contain a shooter detector sensor 170/175 configured to detect the presence of a shooter via detection of a visual muzzle flash or audible gunshot sound. The housing 152 may include a door position sensor 184 configured to detect door open and door close events. The one or more sensors may include at least one of a motion sensor, a tamper sensor, a smoke sensor, a temperature sensor, an occupancy sensor, or a light detection and ranging sensor.

The smart lock device may include onboard request-to-exit motion detection capability. A motion sensor may be mounted adjacent to a door handle of the door 154. The motion sensor may be configured to detect motion within a motion sensor field of view directed toward the door handle. The controller 150 may be configured to place the locking device 200 in an unlocked configuration in response to the motion sensor detecting motion at or near the door handle.

The smart lock device may use less than one-fifth of the power of a traditional magnetic lock for energy-efficient operation. The smart lock device may be configured as a single self-contained unit that integrates the locking device 200, the camera 180, and the one or more sensors within the housing 152. The single self-contained unit may eliminate the need for separate equipment installations for access control, video surveillance, and environmental monitoring at each secured portal. The integrated design may reduce equipment costs and simplify procurement compared to installations requiring separate components from multiple vendors.

The security system 100 may be deployed in different product configurations based on facility requirements and budget considerations. A base locking system configuration may include the locking device 200 with local door protection and basic access control capabilities. The base locking system configuration may be suitable for schools, places of worship, safe rooms, and projects with limited budgets. A low voltage locking system configuration may include the locking device 200 with traditional access control integration for retrofit installations. The low voltage locking system configuration may be suitable for hotels, retail centers, and small businesses. A Power-over-Ethernet configuration may include the locking device 200 with bidirectional camera technology and comprehensive monitoring capabilities. The Power-over-Ethernet configuration may be suitable for enterprise deployments, medium-size businesses, government facilities, and financial institutions.

The smart lock device may receive power and connectivity through a single LAN cable via the Power-over-Ethernet interface. The single cable installation may reduce installation complexity and installation time compared to traditional access control installations requiring separate power and data wiring. The simplified wiring configuration may enable faster installation times for deployment across multiple secured portals within a physical facility.

The smart lock device may be upgradable over time. The modular nature of the housing 152 and the printed circuit board 212 may enable replacement or upgrade of individual components without replacing the entire smart lock device. Sensor modules, camera modules, and processing components may be upgraded as technology advances. Software and firmware updates may be deployed to the controller 150 via the communications network 130 to add new features or improve performance without physical modification of the smart lock device.

The door 154 may be positioned within the door frame 156 in a closed configuration. The door 154 may pivotally swing away from and toward the door frame 156 to allow for a user to enter through and exit from the door assembly.

The controller 150 may include a processor, a computer readable medium, a database, and an input/output module or control panel having a display. The processor may refer to a general-purpose or specific-purpose processing device including but not limited to a microprocessor, a microcontroller, a state machine, or a combination of computing devices. The computer readable medium may reside in RAM memory, flash memory, ROM memory, EPROM memory, EEPROM memory, registers, hard disk, a removable disk, or any other form of computer-readable medium. The computer readable medium may be coupled to the processor such that the processor may read information from, and write information to, the computer readable medium. The processor and the computer readable medium may reside in an application specific integrated circuit (ASIC) or as discrete components.

The controller 150 may include a transceiver for wired or wireless communication. The transceiver may permit communications across a communication medium using communication protocols including Ethernet, Bluetooth, Wi-Fi, wireless application protocol, or IEEE 802 standards. The transceiver may be configured to communicate with a software application running on a device and permit a user to cause the controller 150 to actuate various operations corresponding to a user's command.

The smart lock device may include a locking device 200 configured to selectively restrict movement of the door 154 associated with the corresponding secured portal. The locking device 200 may include a chassis, a lifting member, a stop plate, and an actuator configured to manipulate the locking device 200 between a locked configuration and an unlocked configuration. The actuator may comprise a servo or any actuating device capable of manipulating a physical location of the lifting member. The actuator may be configured to provide an output corresponding to the locked configuration and the unlocked configuration. The chassis may be modular such that the chassis may receive a variety of components in various configurations. Components associated with the chassis may be interchanged based on a desired application. The components may also be replaced when the components become outdated or reach an end of useful life without having to replace the chassis.

The locking device 200 may be configured to be coupled directly to the door 154 and function in combination with the stop plate coupled to the door frame 156 surrounding the door 154. The stop plate may be aligned with at least a portion of the lifting member for restricting movement of the door 154 when the lifting member is raised. In another configuration, the locking device 200 may be configured to be coupled directly to the door frame 156 and function in combination with the stop plate coupled to the door 154. The stop plate may be aligned with at least a portion of the lifting member for restricting movement of the door 154 within the door frame 156 when the lifting member is raised.

In the locked configuration, the lifting member may be raised such that the door 154 may not move away from the door frame 156. The stop plate may restrict movement of the door 154 by engaging a contact surface of the lifting member. A force associated with opening the door 154 may be translated across the stop plate and into a surface to which the stop plate is mounted, such as the door frame 156.

In the unlocked configuration, the lifting member may be lowered such that the door 154 may move freely away from the door frame 156. When the door 154 is moved away from the door frame 156, the lifting member may pass underneath the stop plate without contacting the stop plate. The housing 152 may be positioned at an upper corner junction where the door 154 meets the door frame 156, enabling the camera 180 and sensor components to monitor both interior and exterior areas adjacent to the secured portal.

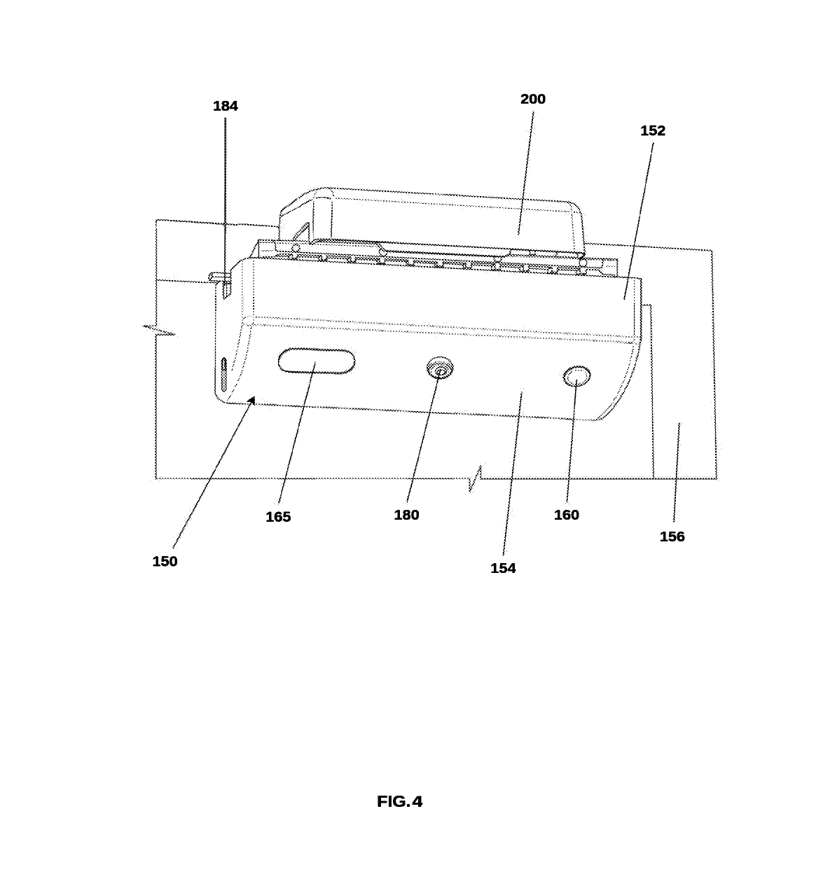

FIG. 4 illustrates a side cross-sectional view of a smart lock device in a second embodiment with a door 154 in a closed position. The smart lock device may include a housing 152 mounted at an upper portion of the door 154 adjacent to a door frame 156. The housing 152 may contain a controller 150 and associated sensor components.

A camera 180 may be integrated within the housing 152. The camera 180 may be configured to capture video data and audio data of at least one of an interior area or an exterior area adjacent to a corresponding secured portal. The housing 152 may contain an occupancy sensor 160 configured to detect the presence of occupants within a room or area adjacent to the secured portal. The housing 152 may contain a smoke/fire/heat sensor 165 configured to detect smoke, fire, heat, or other environmental conditions. The housing 152 may include a door position sensor 184 configured to detect door open and door close events.

The door 154 may be positioned within the door frame 156 in a closed configuration. A locking device 200 may be associated with the smart lock device and may be configured to selectively restrict movement of the door 154. The locking device 200 may include a lifting member configured to elevate during operation of the locking device 200. In some aspects, the lifting member may translate a force applied by contact with the door 154 downwardly into a mounting surface to which the locking device 200 is mounted, thereby increasing an amount of force capable of being resisted by the locking device 200. The housing 152 may be positioned at an upper corner junction where the door 154 meets the door frame 156, enabling the camera 180 and sensor components to monitor both interior and exterior areas adjacent to the secured portal.

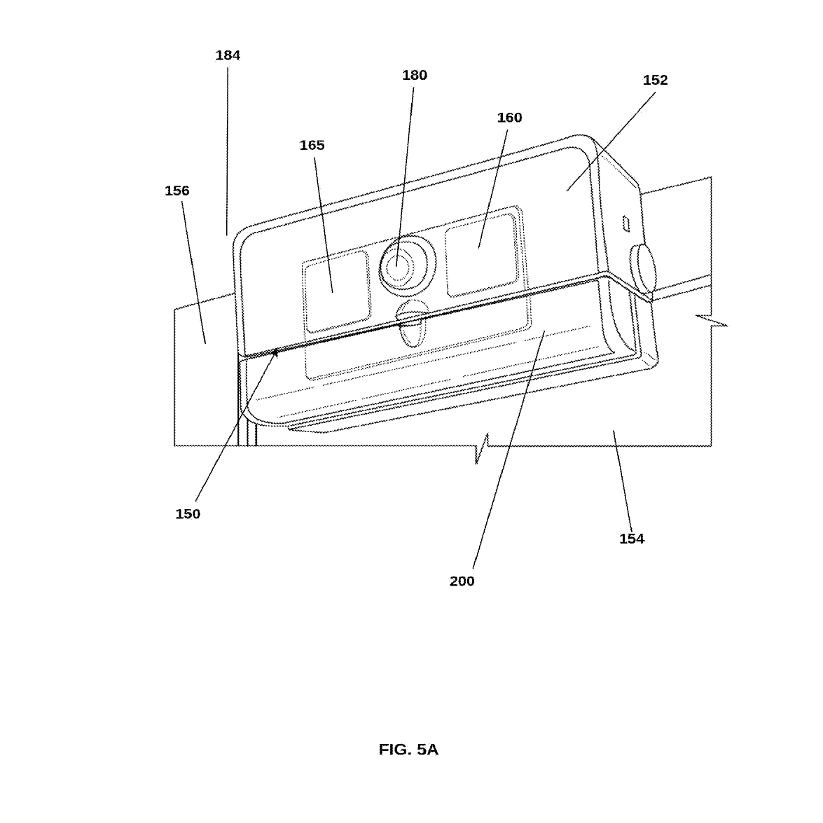

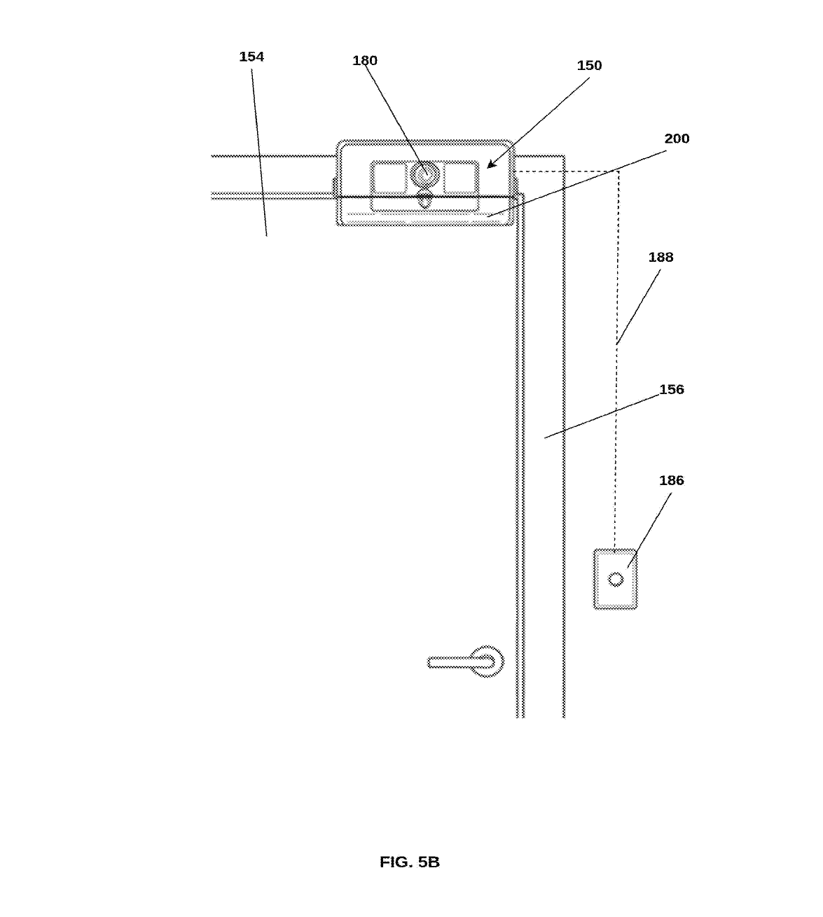

FIG. 5A and FIG. 5B illustrate perspective views of a smart lock device 150 installed on a door assembly in a third embodiment according to aspects of the present disclosure. As described above, a plurality of smart lock devices may be distributed at secured portals throughout a physical facility. Each smart lock device 150 may comprise a camera 180 configured to capture real-time video data and one or more sensors configured to capture sensor data.

The smart lock device 150 may include a housing 152 mounted at an upper portion of a door 154 adjacent to a door frame 156. The housing 152 may contain the controller 150 and associated sensor components. The door 154 may be positioned within the door frame 156 in a closed configuration.

The smart lock device 150 may include a camera 180 integrated within the housing 152. The camera 180 may include a camera lens array visible on a front panel of the housing 152. The camera lens array may include a rectangular display or sensor window on a left side, a circular lens aperture in a center portion, and a rectangular display or sensor window on a right side. The camera 180 may be configured to capture video data and audio data of at least one of an interior area or an exterior area adjacent to a corresponding secured portal.

The housing 152 may contain an occupancy sensor 160 configured to detect the presence of occupants within a room or area adjacent to the secured portal. The housing 152 may contain a smoke/fire/heat sensor 165 configured to detect smoke, fire, heat, or other environmental conditions. The housing 152 may include a door position sensor 184 configured to detect door open and door close events.

The smart lock device 150 may include optional sensor additions based on application requirements. The optional sensor additions may include a mapping sensor configured to capture location data for asset tracking applications. The optional sensor additions may include an air quality sensor configured to detect air quality conditions including particulate matter, volatile organic compounds, or other air quality indicators. The optional sensor additions may include a filtered camera configured to apply privacy filtering to captured video data. The filtered camera may include blurring or masking features that protect the privacy of individuals detected by the camera while still enabling occupancy detection and movement tracking. The optional sensor additions may be integrated into the housing 152 or connected to the controller 150 via the terminal block 216.

A bottom portion of the housing 152 may feature a hinged or removable cover panel. The hinged or removable cover panel may be opened for access to internal components, wiring connections, or battery compartments within the housing 152. A rounded protrusion may be visible on a side of the housing 152, which may serve as a button, an indicator, or an additional sensor component.

The smart lock device 150 may include a locking device 200 configured to selectively restrict movement of the door 154 associated with the corresponding secured portal. The housing 152 may be positioned at an upper corner junction where the door 154 meets the door frame 156, enabling the camera 180 and sensor components to monitor both interior and exterior areas adjacent to the secured portal.

Referring to FIG. 5B, the smart lock device 150 may include a control panel 186 mounted on the door frame 156. The control panel 186 may include a circular element that may serve as a button or indicator for user interaction with the smart lock device. A LAN connection 188 may extend vertically from the housing 152 along the door frame 156 to the control panel 186. The LAN connection 188 may indicate a connection pathway for Power over Ethernet connectivity. The LAN connection 188 may enable the smart lock device to receive both power and data through a single network connection.

The smart lock device 150 may include a motion sensor configured to detect motion within a motion sensor field of view. The motion sensor may be mounted adjacent to a door handle of the door 154. The motion sensor field of view may be directed toward the door handle. The controller 150 may be configured to place the locking device 200 in an unlocked configuration in response to the motion sensor detecting motion at or near the door handle.

The motion sensor field of view may be adjustable. In some aspects, the motion sensor field of view may be adjusted by modifying a distance between a sensing member and a sensing hole of the motion sensor. In some aspects, the motion sensor field of view may be adjusted by modifying a diameter of the sensing hole.

The motion sensor may include a battery or other power source. The motion sensor may be powered via the battery and thus independently from the locking device 200. The locking device 200 may be configured such that when the battery of the motion sensor reaches a threshold level of remaining power, the motion sensor draws power from the associated locking device 200. The motion sensor may avoid inoperability by drawing power from the locking device 200 when the battery power level reaches the threshold level.

The smart lock device 150 may be configured to operate with aging doors and existing door assemblies. The housing 152 may be designed for retrofit installation on door assemblies of varying ages and conditions. The locking device 200 may accommodate variations in door alignment and door frame conditions that may occur in aging door assemblies. The smart lock device 150 may provide modern access control capabilities to facilities with existing door infrastructure without requiring replacement of the door assemblies.

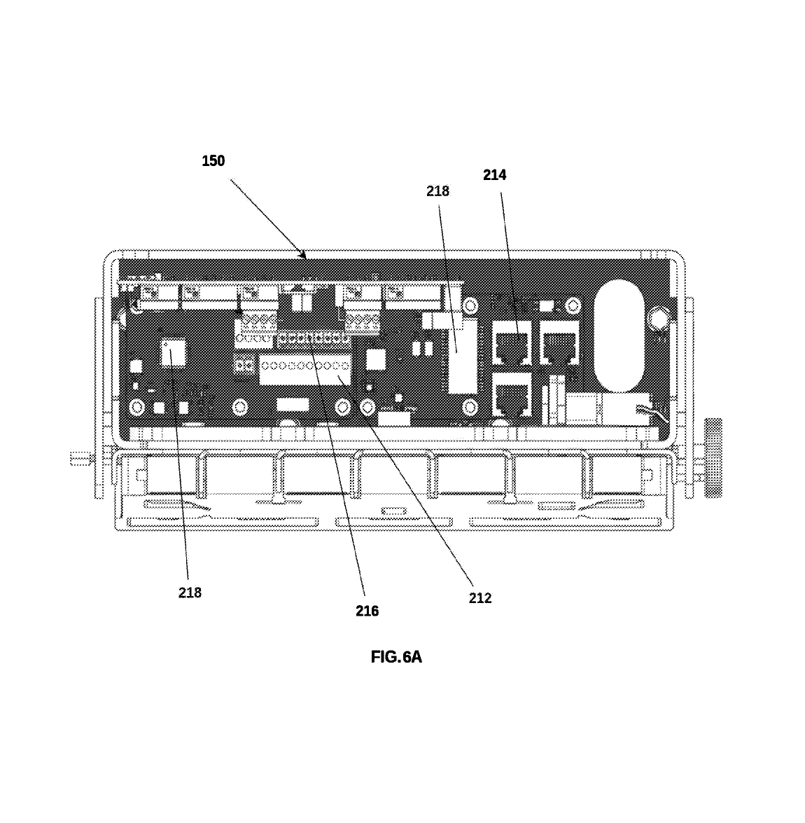

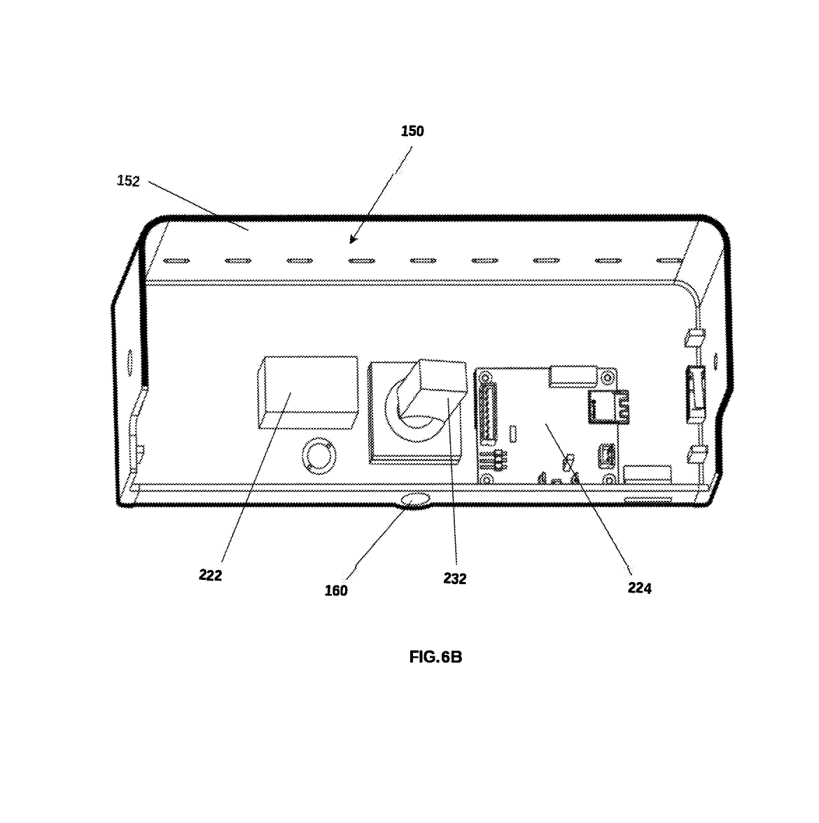

FIG. 6A illustrates a perspective view of internal components of a smart lock device according to aspects of the present disclosure. The smart lock device may include the controller 150 associated with a printed circuit board 212. The printed circuit board 212 may house various electronic components for controlling operations of the smart lock device.

The printed circuit board 212 may include a processor 218. The processor 218 may be configured to receive output signals from one or more sensors, process the received output signals, and generate control signals for controlling operations of the locking device 200. The processor 218 may refer to a general-purpose or specific-purpose processing device including but not limited to a microprocessor, a microcontroller, a state machine, or a combination of computing devices.

The printed circuit board 212 may include an ethernet port 214. The ethernet port 214 may be an RJ45 ethernet port configured to provide Power over Ethernet connectivity. The ethernet port 214 may enable the smart lock device to receive both power and data through a single network connection.

The printed circuit board 212 may include a terminal block 216. The terminal block 216 may provide connection points for external wiring. The terminal block 216 may enable connection of external devices such as card readers, request-to-exit sensors, and other access control peripherals. The terminal block 216 may also provide connection points for power inputs and communication interfaces.

The terminal block 216 may enable connection of external card readers for credential-based access control. The external card readers may include proximity card readers, smart card readers, or biometric readers. The controller 150 may receive credential data from the external card readers via the terminal block 216 and process the credential data to determine whether to grant access. In some aspects, a request-to-exit button may be connected to the terminal block 216 to enable manual egress requests.

The printed circuit board 212 may include integrated circuit components comprising microcontrollers, memory devices, and communication interfaces. The printed circuit board 212 may include connectors for interfacing with additional modules and components within the smart lock device. In some aspects, a row of test points may be positioned along an upper edge of the printed circuit board 212.

The controller 150 may include a vertical column of cylindrical energy storage components positioned adjacent to the printed circuit board 212. The cylindrical energy storage components may provide backup power to the smart lock device and support actuation of the locking device 200.

The smart lock device may include a control interface board connected to a front panel board 224 via a ribbon cable. The ribbon cable may carry data and control signals between the control interface board and the front panel board 224. In some aspects, an oval-shaped aperture may be visible on a side of the printed circuit board 212, which may accommodate a camera module or sensor component. The printed circuit board 212 may be enclosed within a rectangular housing that provides structural support and protection for the internal electronic components.

FIG. 6B illustrates a three-dimensional cutaway perspective view of internal components of a smart lock device according to aspects of the present disclosure. The smart lock device may include the housing 152 that encloses the internal components and provides structural support for the device.

The controller 150 may be associated with the internal components and may be configured to receive output signals from one or more sensors, process the received output signals, and generate control signals for controlling operations of the locking device 200. The controller 150 may be operably connected to the front panel board 224. The front panel board 224 may include connection points for ethernet, WiFi, and Bluetooth connectivity. The front panel board 224 may include ribbon cable connectors for interfacing with a control interface board. The front panel board 224 may include terminal blocks for electrical connections.

A camera module 232 may be positioned within the housing 152. The camera module 232 may be configured to capture real-time video data and audio data of at least one of an interior area or an exterior area adjacent to a corresponding secured portal. The camera module 232 may include a lens aperture for image capture and a microphone for audio capture. The camera module 232 may feed real-time event data to other components of the security system 100.

A battery 222 may be positioned within a battery compartment of the housing 152. The battery 222 may provide power to the smart lock device. The battery 222 may provide backup power in the event of a power interruption to a Power over Ethernet connection.

The occupancy sensor 160 may be included within the housing 152. The occupancy sensor 160 may be configured to detect the presence of occupants within a room or area adjacent to a secured portal. The occupancy sensor 160 may generate output signals representing an occupancy state of the adjacent area.

The housing 152 may include a row of ventilation slots along an upper surface to provide airflow for internal components. The arrangement of the controller 150, the front panel board 224, the camera module 232, the battery 222, and the occupancy sensor 160 within the housing 152 may provide an integrated smart lock device capable of capturing video data, detecting occupancy, and controlling access at a secured portal.

The printed circuit board 212 may be modular such that the printed circuit board 212 may receive a variety of components in various configurations. Components associated with the printed circuit board 212 may be interchanged based on a desired application. The components may also be replaced when the components become outdated or reach an end of useful life without having to replace the printed circuit board 212. The modular nature of the printed circuit board 212 may enable the smart lock device to adapt to future desired applications.

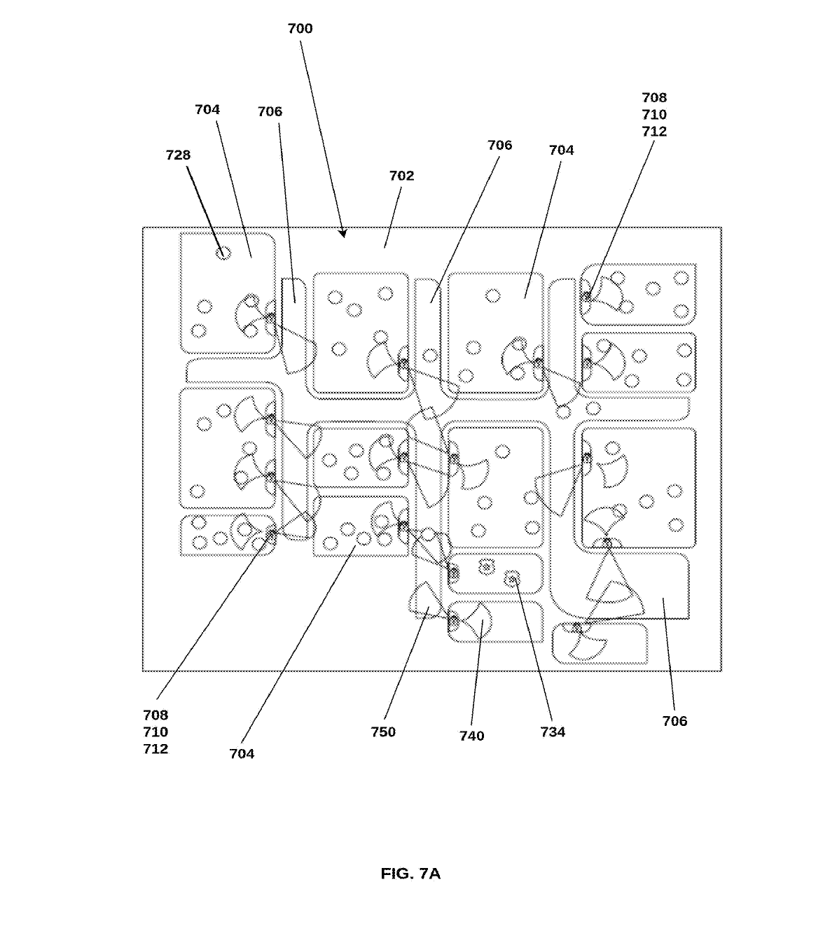

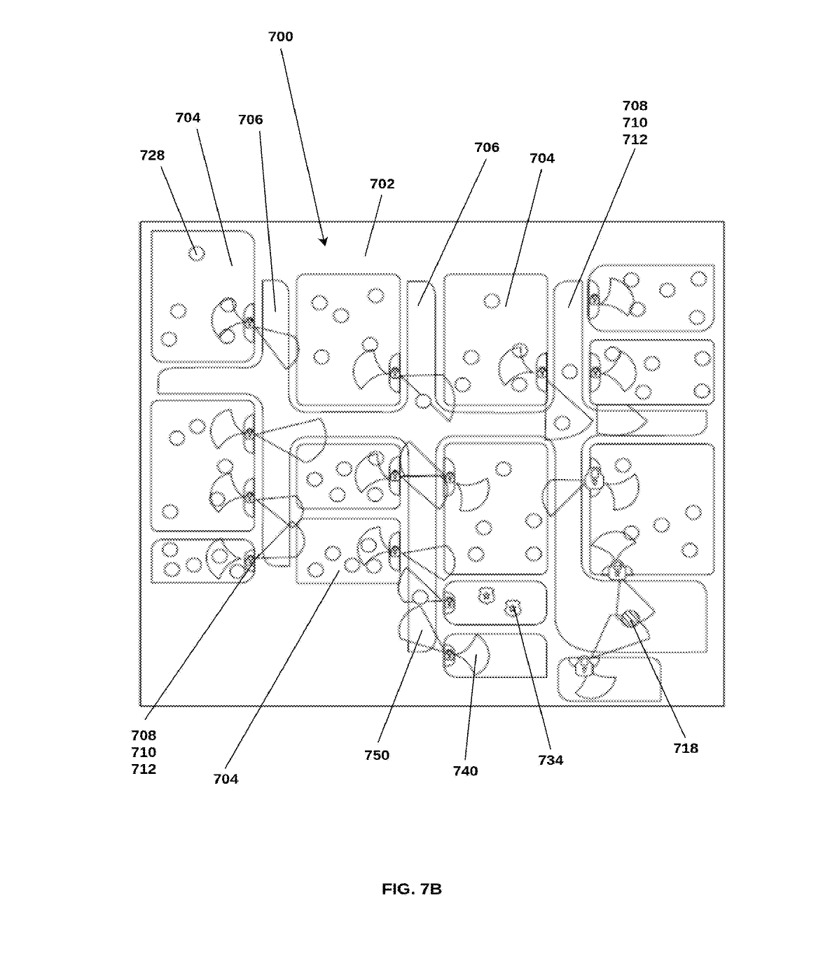

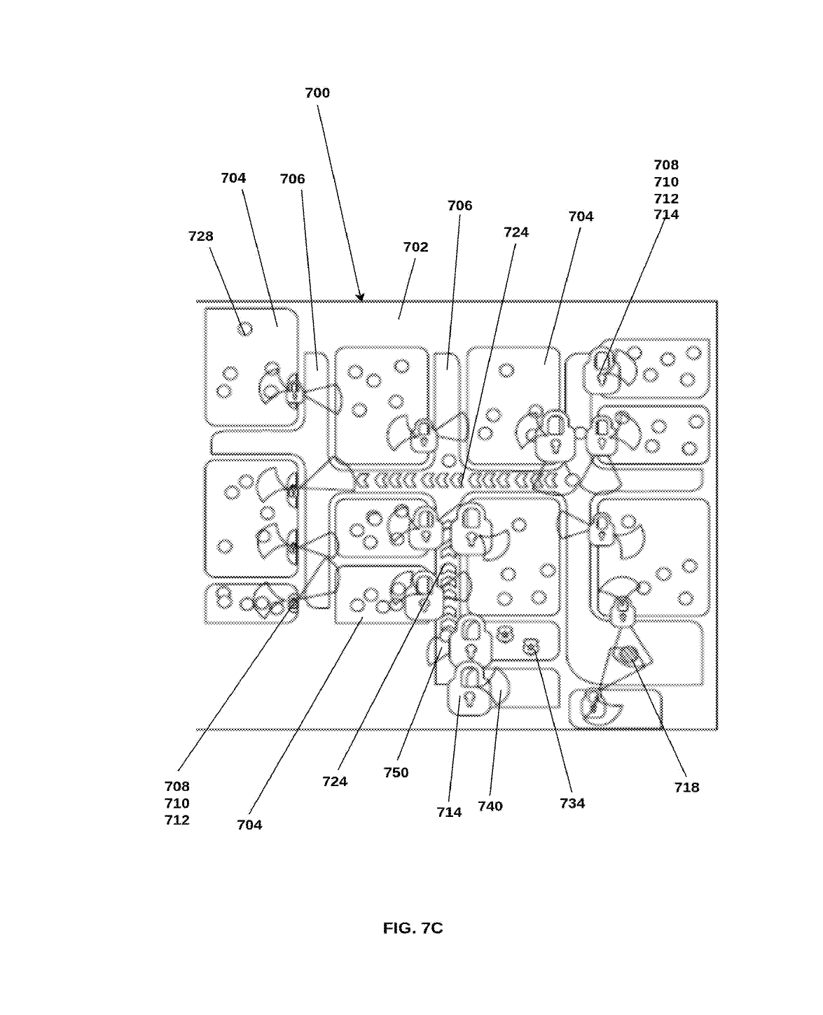

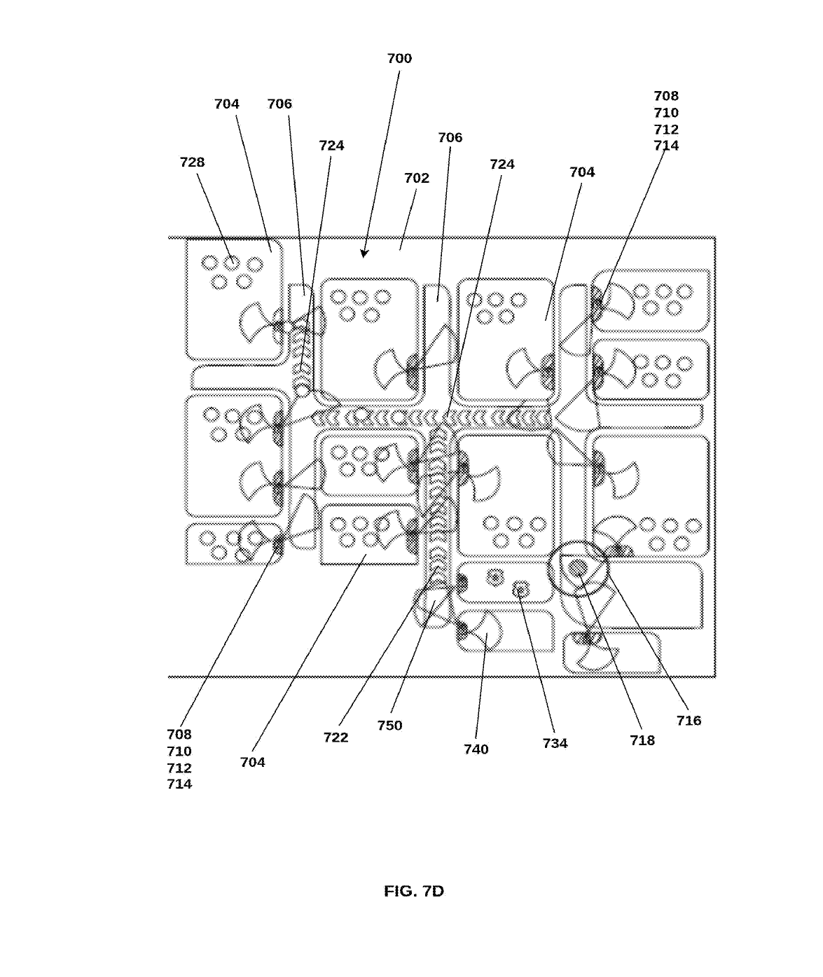

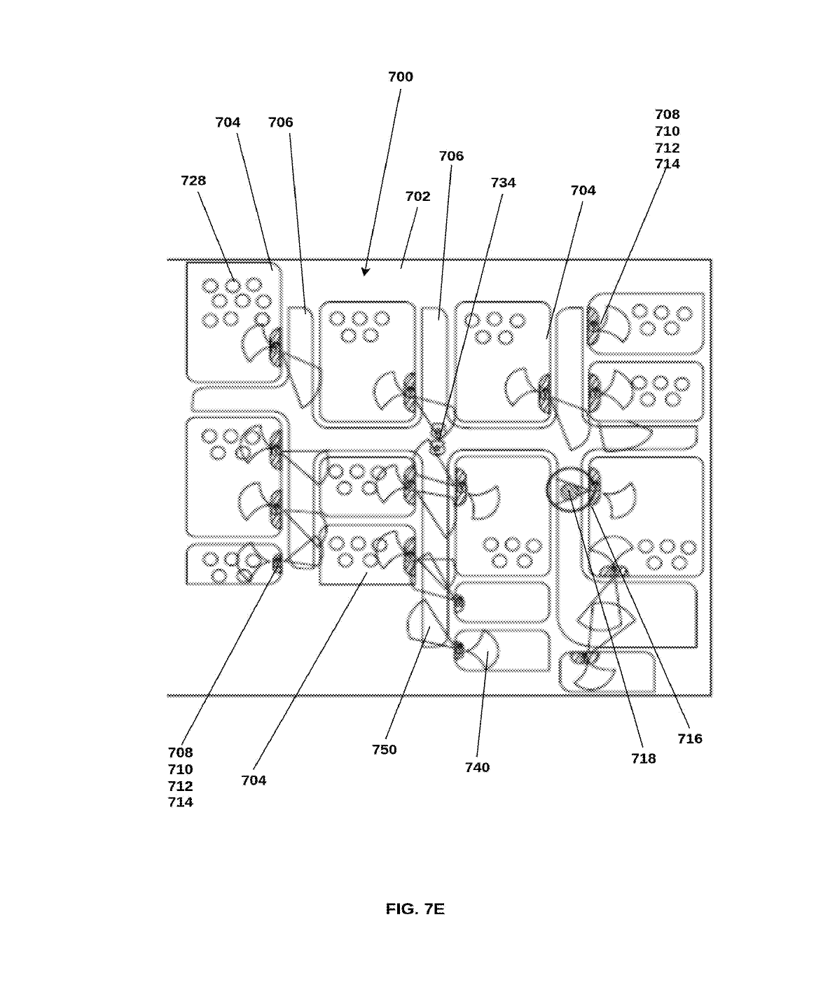

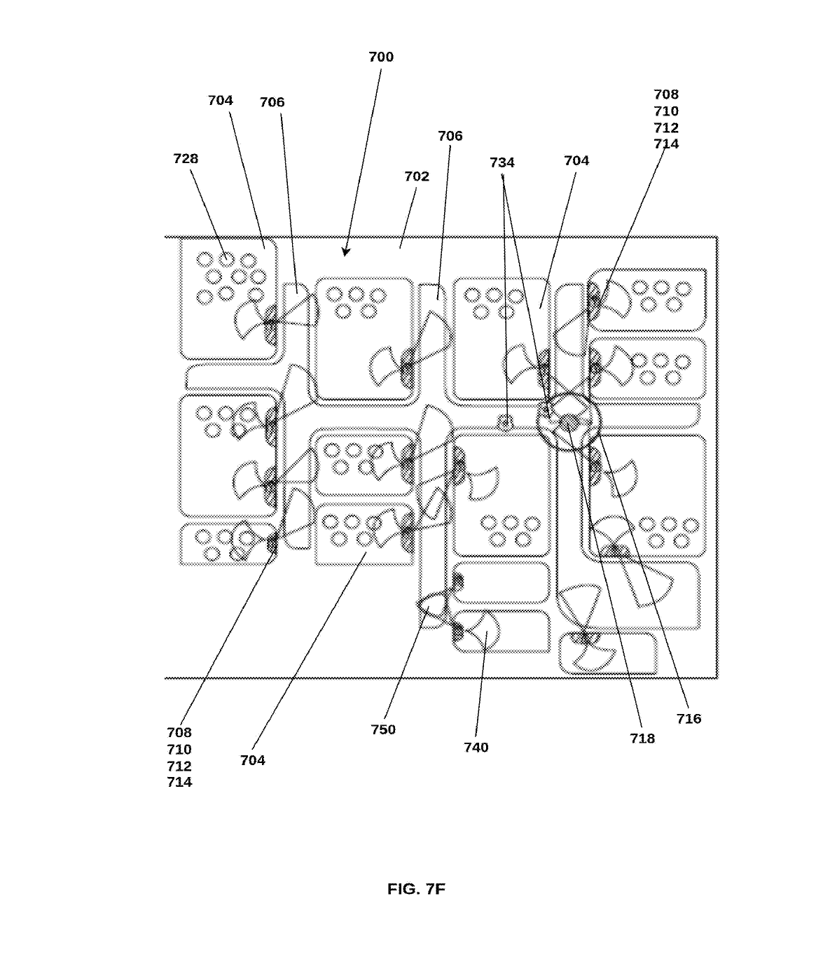

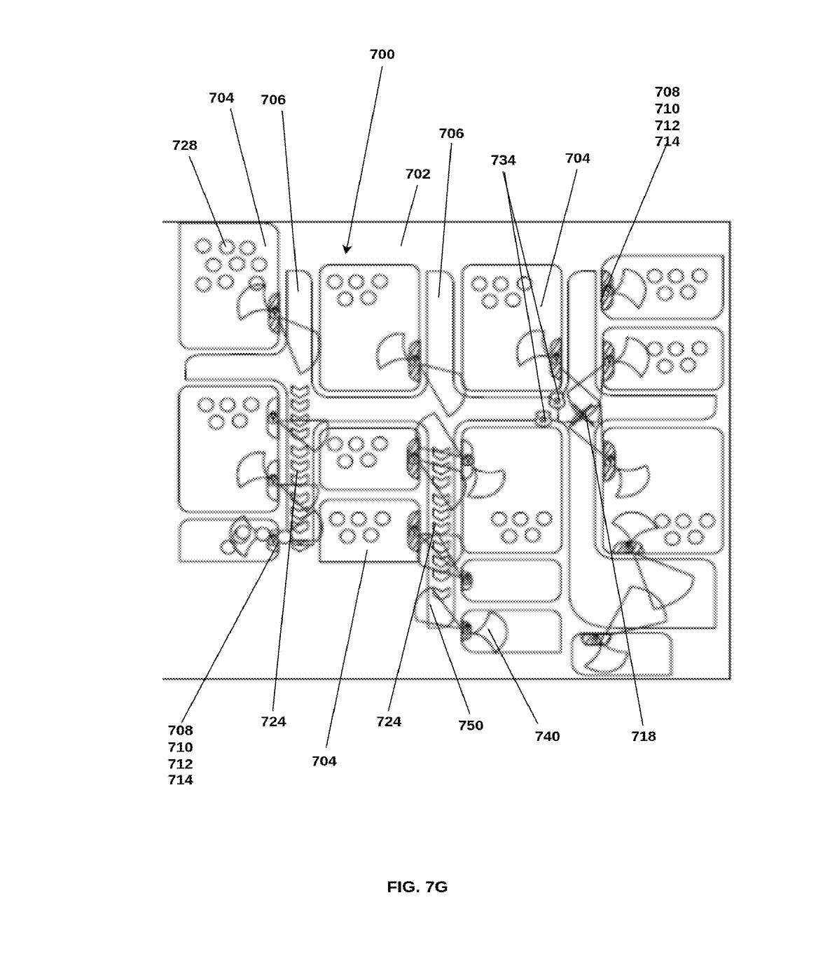

FIG. 7A and FIG. 7B illustrate two-dimensional views of a graphical user interface (GUI) for a Sensor Activated Notification System 700 displaying a building layout 702 of a physical facility according to aspects of the present disclosure. The Sensor Activated Notification System 700 may provide Security Operations Center integration for viewing real-time building activity within the physical facility.

Referring to FIG. 7A, the building layout 702 may include a plurality of rooms 704 arranged in a grid pattern and one or more hallways 706 connecting the rooms 704. The building layout 702 may represent a two-dimensional floor plan view of the physical facility that enables security personnel to monitor conditions throughout the physical facility.

A plurality of cameras 708 may be distributed throughout the building layout 702 at locations corresponding to secured portals within the physical facility. As described above, positions of the plurality of cameras 708 may be calibrated within the three-dimensional spatial model to enable accurate representation of camera coverage areas. The plurality of cameras 708 may capture real-time video data from respective areas within the physical facility.

A plurality of door sensors 710 may be positioned at doorways within the building layout 702 to indicate status of corresponding doors. The door sensors 710 may detect door open and door close events at each secured portal.

A plurality of occupancy sensors 712 may be positioned within the rooms 704 and hallways 706 to detect presence of occupants within the corresponding areas. The occupancy sensors 712 may generate output signals representing an occupancy state of each monitored area. The system may provide occupancy monitoring to optimize security staffing or trigger alerts for over-occupancy conditions based on data received from the occupancy sensors 712.

One or more occupant markers 728 may indicate detected positions of occupants within the rooms 704. The occupant markers 728 may be displayed as visual indicators overlaid onto the building layout 702 to show locations of detected individuals. The system may detect person tracking across multiple cameras 708 to monitor movement patterns throughout the physical facility. The real-time video data from the plurality of cameras 708 may be stitched together and overlaid onto the three-dimensional spatial model to generate an interactive digital twin of the physical facility.

An emergency services indicator 734 may indicate activation of emergency services or emergency response status. The emergency services indicator 734 may be displayed within the Sensor Activated Notification System 700 to provide visual confirmation that emergency services have been notified.

Internal camera views represented by curved fans 740 may indicate fields of view of cameras 708 directed toward interiors of the rooms 704. The internal camera views represented by curved fans 740 may visually represent coverage areas within the rooms 704, enabling security personnel to identify which portions of each room 704 are within the field of view of a corresponding camera 708.

External camera views represented by straight fans 750 may indicate fields of view of cameras 708 directed toward the hallways 706 or exterior areas adjacent to the rooms 704. The external camera views represented by straight fans 750 may visually represent coverage areas outside of the rooms 704. The combination of internal camera views represented by curved fans 740 and external camera views represented by straight fans 750 may provide comprehensive camera coverage visualization across the physical facility displayed within the building layout 702.

Referring to FIG. 7B, the Sensor Activated Notification System 700 may display an intruder marker 718 indicating a detected position of an intruder or threat within the building layout 702. The intruder marker 718 may be displayed as a visual indicator overlaid onto the building layout 702 to show a location of a detected threat. The Sensor Activated Notification System 700 may enable filtering alerts by severity and replaying breach events across high-risk areas within the physical facility.

The Sensor Activated Notification System 700 may enable real-time virtual navigation through the interactive digital twin via a user interface. Security personnel may use the Sensor Activated Notification System 700 to virtually navigate through the physical facility in real-time by selecting different areas within the building layout 702 for detailed viewing.

FIG. 7C, FIG. 7D, FIG. 7E, FIG. 7F, and FIG. 7G illustrate additional two-dimensional views of the Sensor Activated Notification System 700 displaying security status and zone information within the building layout 702 according to aspects of the present disclosure.

Referring to FIG. 7C, a plurality of lock status indicators 714 may be displayed at doorways within the building layout 702. Each lock status indicator 714 may indicate a locked or unlocked status of a corresponding locking device 200. The lock status indicators 714 may provide visual confirmation of security status at each secured portal within the physical facility. The lock status indicators 714 may be updated in real-time based on data received from the plurality of smart lock devices distributed at secured portals throughout the physical facility. As described above, the plurality of cameras 708 may be integrated within smart lock devices positioned at secured portals throughout the physical facility.

One or more safe zones 724 may indicate areas within the building layout 702 that have been verified as secure. The safe zones 724 may be identified based on lock status data indicating that corresponding locking devices 200 are in a locked configuration and occupancy data indicating that no threats are present within the corresponding areas. The safe zones 724 may be displayed as visual overlays within the building layout 702 to enable security personnel and first responders to identify rooms that have been cleared or verified as secure.

Referring to FIG. 7D, one or more alert zones 716 may highlight areas within the building layout 702 where security events have been detected. The alert zones 716 may be displayed as visual indicators overlaid onto the building layout 702 to draw attention to areas requiring immediate response. The alert zones 716 may be generated in response to sensor data indicating at least one of occupancy data, environmental condition data, or access event data. The digital twin interface may overlay sensor data onto the interactive digital twin, the sensor data including at least one of occupancy data, environmental condition data, or access event data.

One or more first responder routes 722 may indicate navigation paths for first responders to reach locations within the physical facility. The first responder routes 722 may be calculated based on the building layout 702, the location of detected threats indicated by the intruder marker 718, and the locations of safe zones 724. The first responder routes 722 may be displayed as visual pathways overlaid onto the building layout 702 to guide first responders from an entry point of the physical facility to a target location. The first responder routes 722 may be updated in real-time as conditions within the physical facility change.

The digital twin interface may enable first responders to virtually clear a facility before physically entering during emergency situations. First responders may utilize the Sensor Activated Notification System 700 remotely to gain real-time awareness of the interior of the physical facility and the conditions therein. First responders may gain an understanding of the layout of the interior of the physical facility prior to entering. First responders may identify where a threat is located within the physical facility and physical characteristics of the threat via the intruder marker 718 and associated identification information. The combination of the lock status indicators 714, the alert zones 716, the safe zones 724, and the first responder routes 722 may enable first responders to confidently move through the physical facility possessing information such as the interior layout, the security conditions, and the identity of any detected threats.

Referring to FIG. 7E and FIG. 7F, the Sensor Activated Notification System 700 may display updated positions of the alert zones 716 and the intruder marker 718 as conditions within the physical facility change. The lock status indicators 714 may be updated to reflect changes in lock status at each secured portal. The occupant markers 728 may be updated to reflect movement of occupants within the rooms 704.

Referring to FIG. 7G, the Sensor Activated Notification System 700 may display the safe zones 724 in conjunction with the lock status indicators 714 to provide comprehensive security status visualization. The interior camera views represented by curved fans 740 may enable identification of occupants within secured spaces and support all clear procedures for emergency response. The combination of the safe zones 724, the lock status indicators 714, and the interior camera views represented by curved fans 740 may enable security personnel to verify that rooms have been cleared and are secure.

The system may enable remote compliance audits where fire marshals or inspectors may review the interactive digital twin remotely without physical presence at the physical facility. The digital twin interface may provide remote access to the building layout 702 with overlays indicating the lock status indicators 714, the alert zones 716, the safe zones 724, and sensor event data. Auditors may virtually navigate through the physical facility via the interactive digital twin to verify compliance with safety and security specifications. The remote compliance audit capability may reduce the demand for physical site visits while maintaining comprehensive oversight of facility security conditions.

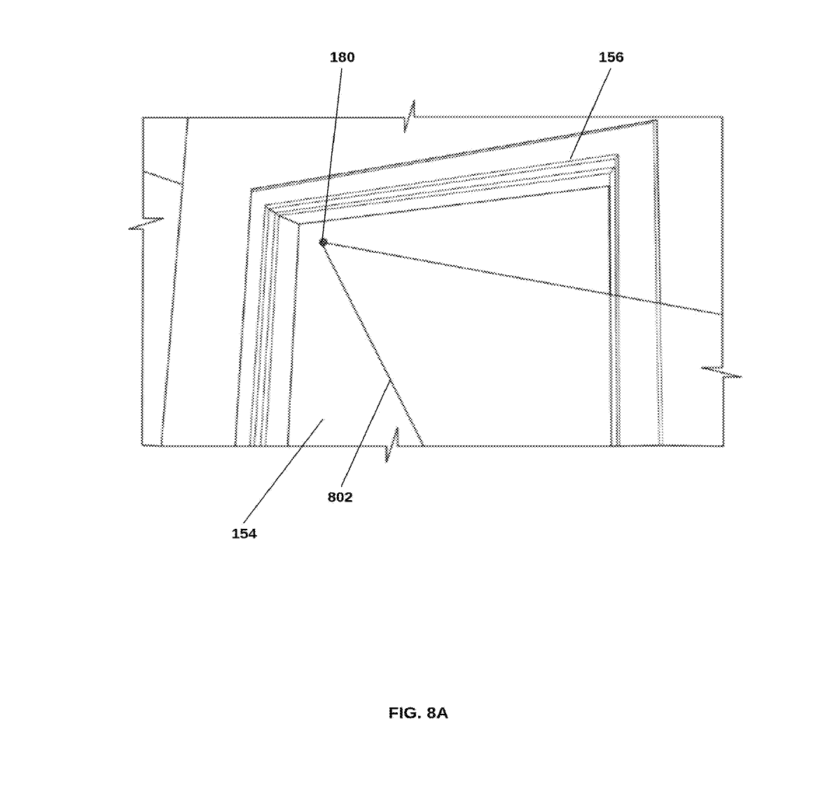

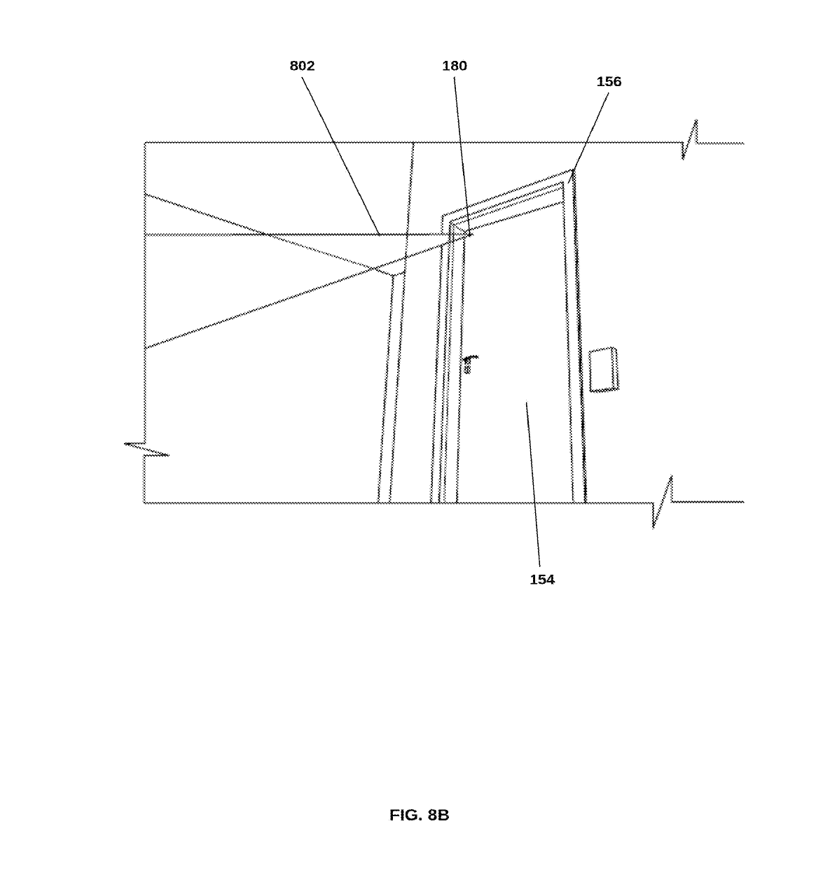

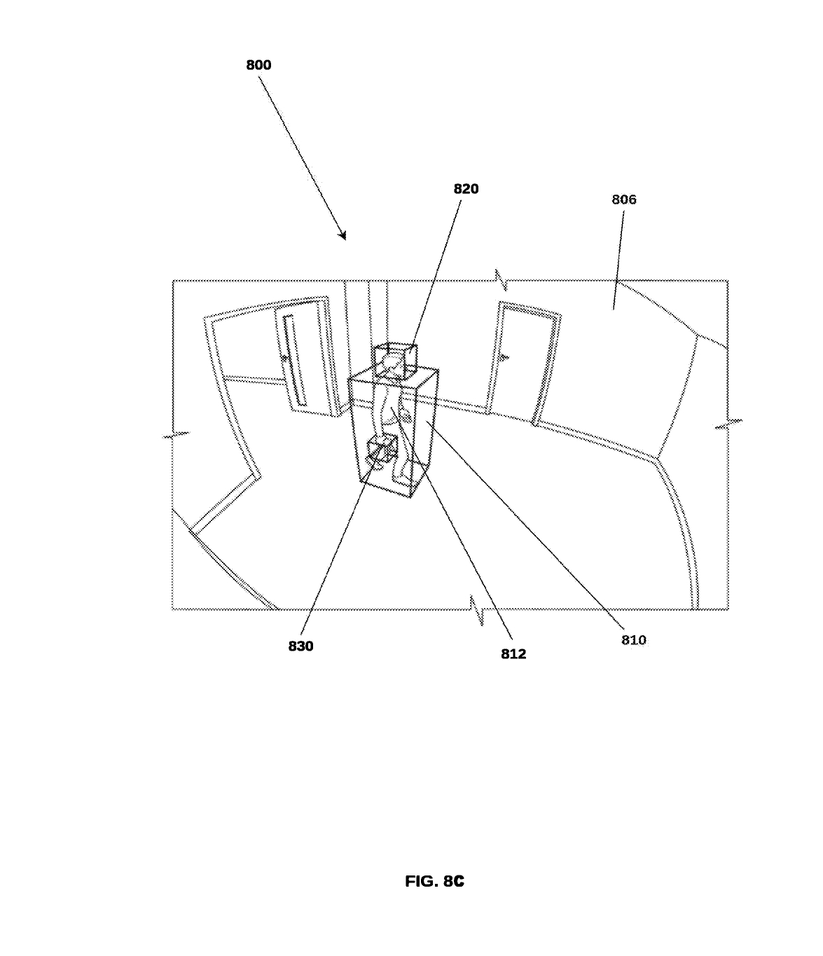

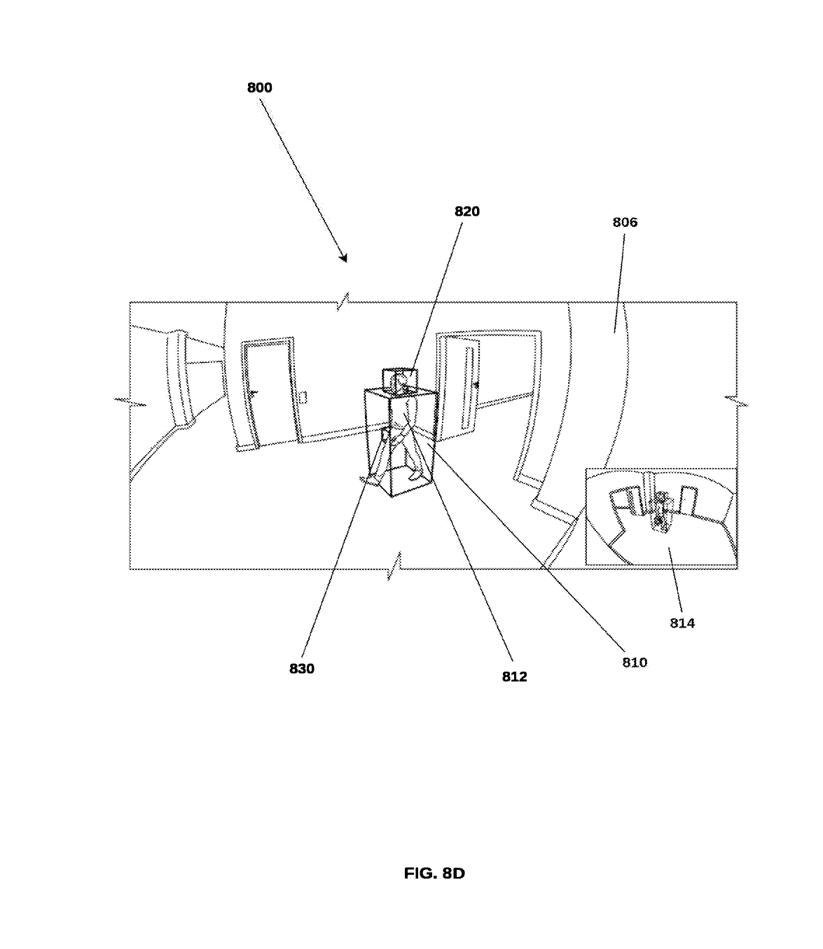

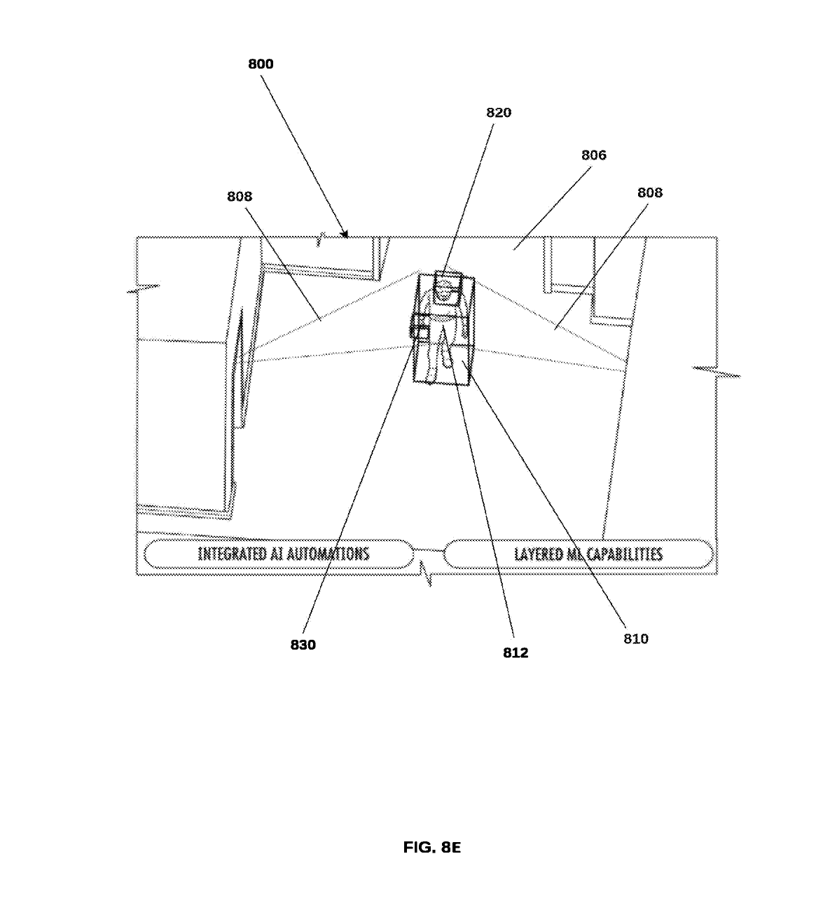

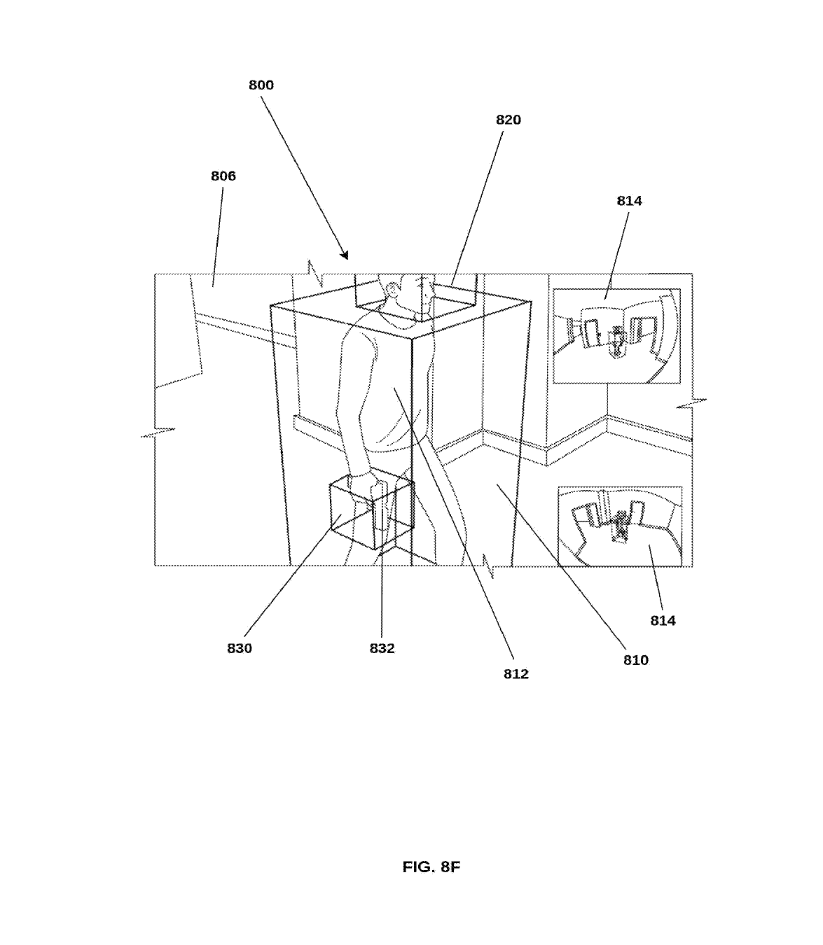

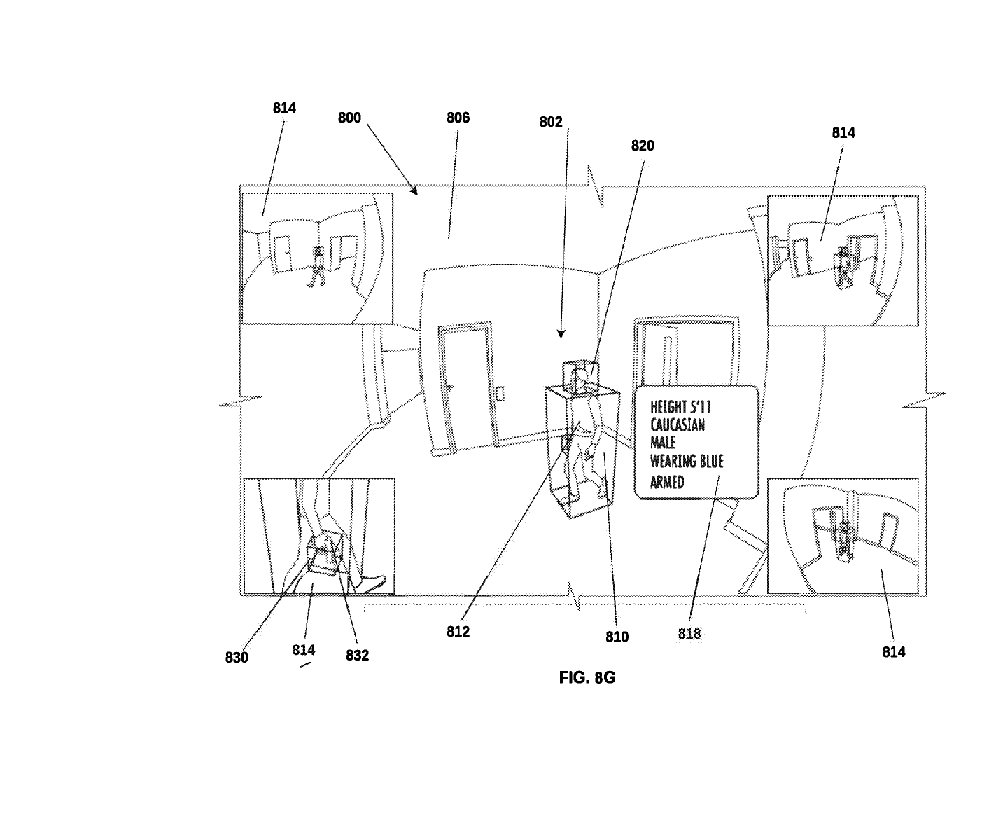

FIG. 8A and FIG. 8B illustrate perspective views within the digital twin environment showing a door 154 installed within the door frame 156 according to aspects of the present disclosure. The digital twin environment may provide three-dimensional visualization of door assemblies and surrounding areas within a physical facility.

Referring to FIG. 8A, an exterior camera view 802 may provide the three-dimensional visualization of the door assembly within the digital twin environment. The door 154 may be shown in a closed position nested within the door frame 156. The door frame 156 may comprise multiple nested rectangular frames arranged in a receding perspective pattern. The multiple nested rectangular frames may create a visual impression of looking through multiple doorways or portals into a virtual space. Lines may extend from a central vanishing point outward toward corners of the image, with directional indicators suggesting camera field of view boundaries.

A camera 180 may be associated with the visualization and may capture the real-time video data that is rendered within the exterior camera view 802. The exterior camera view 802 may demonstrate how the security system 100 processes and integrates visual data from cameras 180 positioned throughout a facility to generate a cohesive real-time visualization within the digital twin environment.

Referring to FIG. 8B, the exterior camera view 802 may provide another perspective view of the door 154 installed within the door frame 156. The door 154 may be shown in a closed position nested within the door frame 156. The door frame 156 may comprise multiple nested rectangular frames arranged in a receding perspective pattern, creating a visual impression of perspective depth within the digital twin environment.

The security system 100 may use depth-sensing cameras in addition to RGB cameras for enhanced depth perception and geometry capture in the digital twin. In some aspects, the depth-sensing cameras may comprise RealSense cameras configured to capture both RGB image data and depth data representing geometry of the physical environment. The depth data may enable the digital twin interface to generate more accurate three-dimensional representations of the physical facility. In some aspects, the security system 100 may use RGB cameras without dedicated depth sensors, wherein depth information may be derived using computational depth estimation techniques.

The camera 180 may capture real-time video data that is rendered within the exterior camera view 802. The exterior camera view 802 may enable security personnel to view the door 154 and the door frame 156 from a perspective that simulates physical presence at the secured portal. The three-dimensional visualization provided by the exterior camera view 802 may enable users to assess conditions at the secured portal without physical presence at the location.

FIG. 8C, FIG. 8D, FIG. 8E, FIG. 8F, and FIG. 8G illustrate perspective views of a digital twin – Intruder Detection System 800 according to aspects of the present disclosure. The digital twin – Intruder Detection System 800 may provide three-dimensional visualization of detected individuals within a physical facility for security monitoring and threat assessment purposes.

Referring to FIG. 8C, the digital twin – Intruder Detection System 800 may display an interior 3D model 806 of a hallway within a physical facility. The interior 3D model 806 may show a three-dimensional representation of a corridor space with multiple doorways visible along walls of the corridor. The interior 3D model 806 may be generated based on spatial data and real-time video data captured from a plurality of cameras distributed throughout the physical facility.

A person silhouette 812 may be displayed within the interior 3D model 806. The person silhouette 812 may represent a detected individual within the monitored environment. A body bounding box 810 may enclose the person silhouette 812. The body bounding box 810 may demarcate the detected person within the three-dimensional visualization.

A head bounding box 820 may be positioned at an upper portion of the person silhouette 812. The head bounding box 820 may enclose a head region of the detected individual. An accessory bounding box 830 may be positioned at a lower portion of the person silhouette 812. The accessory bounding box 830 may enclose an accessory or object associated with the detected individual. The combination of the body bounding box 810, the head bounding box 820, and the accessory bounding box 830 may demonstrate the capability of the digital twin – Intruder Detection System 800 to detect, track, and segment different regions of individuals within the interior 3D model 806 for comprehensive person tracking and identification purposes.

A multi-camera blended view 802 may be generated by combining real-time video data from multiple cameras positioned throughout the physical facility. The multi-camera blended view 802 may provide a unified visualization that integrates video feeds from different vantage points into a cohesive three-dimensional representation.

Referring to FIG. 8D, the digital twin – Intruder Detection System 800 may display the interior 3D model 806 of a hallway with multiple doorways. The person silhouette 812 may be displayed within the body bounding box 810. One or more camera feed insets 814 may be positioned at corners of the visualization. Each camera feed inset 814 may display a different vantage point of the same space from cameras mounted throughout the facility. The camera feed insets 814 may enable security personnel to view the detected individual from multiple angles simultaneously.

Referring to FIG. 8E, the digital twin – Intruder Detection System 800 may display the interior 3D model 806 with one or more camera cones 808 indicating camera coverage areas. Each camera cone 808 may visually represent a field of view of a corresponding camera positioned within the physical facility. The camera cones 808 may enable security personnel to identify which portions of the interior 3D model 806 are within the field of view of corresponding cameras. The person silhouette 812 may be displayed within the body bounding box 810. The head bounding box 820 and the accessory bounding box 830 may segment different regions of the detected individual.

Referring to FIG. 8F, the digital twin – Intruder Detection System 800 may display the interior 3D model 806 of a hallway within a physical facility. The person silhouette 812 may be displayed within the body bounding box 810. The head bounding box 820 may be positioned at an upper portion of the person silhouette 812. The accessory bounding box 830 may be positioned at a lower portion of the person silhouette 812. The accessory bounding box 830 may enclose a weapon 832 associated with the detected individual. The digital twin – Intruder Detection System 800 may detect the weapon 832 based on analysis of the real-time video data using artificial intelligence. Two camera feed insets 814 may be positioned at corners of the visualization, each displaying a different vantage point of the same space from cameras mounted throughout the facility.

Referring to FIG. 8G, the digital twin – Intruder Detection System 800 may display the multi-camera blended view 802 for intruder identification. The person silhouette 812 may be highlighted within the body bounding box 810 in a central three-dimensional view of the interior 3D model 806. The camera cones 808 may indicate coverage areas of cameras positioned throughout the physical facility.

A height/description box 818 may display detected individual parameters. The height/description box 818 may include at least one of height, ethnicity, gender, clothing description, or armed status of the detected individual. The height/description box 818 may provide identification information that may be transmitted to first responders or security personnel. The camera feed insets 814 may be positioned at corners of the visualization to show different vantage points.

As described above, an edge computing module may be configured to perform object detection and anomaly detection using artificial intelligence on the real-time video data. The edge computing module may be configured to detect security anomalies including at least one of forced entry, tailgating, unauthorized loitering, or door propping. The digital twin – Intruder Detection System 800 may detect an anomaly within the physical facility based on the real-time video data using artificial intelligence and generate an alert in response to detecting the anomaly. The anomaly may include at least one of forced entry, tailgating, unauthorized loitering, or door propping.

The digital twin – Intruder Detection System 800 may support weapon tracking and chain of custody monitoring for armory and military storage applications. The digital twin – Intruder Detection System 800 may detect the weapon 832 carried by an individual and track movement of the weapon 832 within the physical facility. The digital twin – Intruder Detection System 800 may log weapon movement events to a distributed ledger to maintain an immutable chain of custody record.

The digital twin – Intruder Detection System 800 may provide disaster simulation capabilities for events including floods, electromagnetic pulses, and fire scenarios. The disaster simulation capabilities may enable emergency response training and disaster planning within the digital twin environment. The disaster simulation capabilities may support NERC audit compliance for power and energy infrastructure facilities by enabling visualization and simulation of disaster scenarios without affecting physical security systems of the physical facility. In some aspects, the disaster simulation capabilities may be offered via a subscription model for VR threat modeling tools, enabling users to access disaster simulation features on a recurring basis.

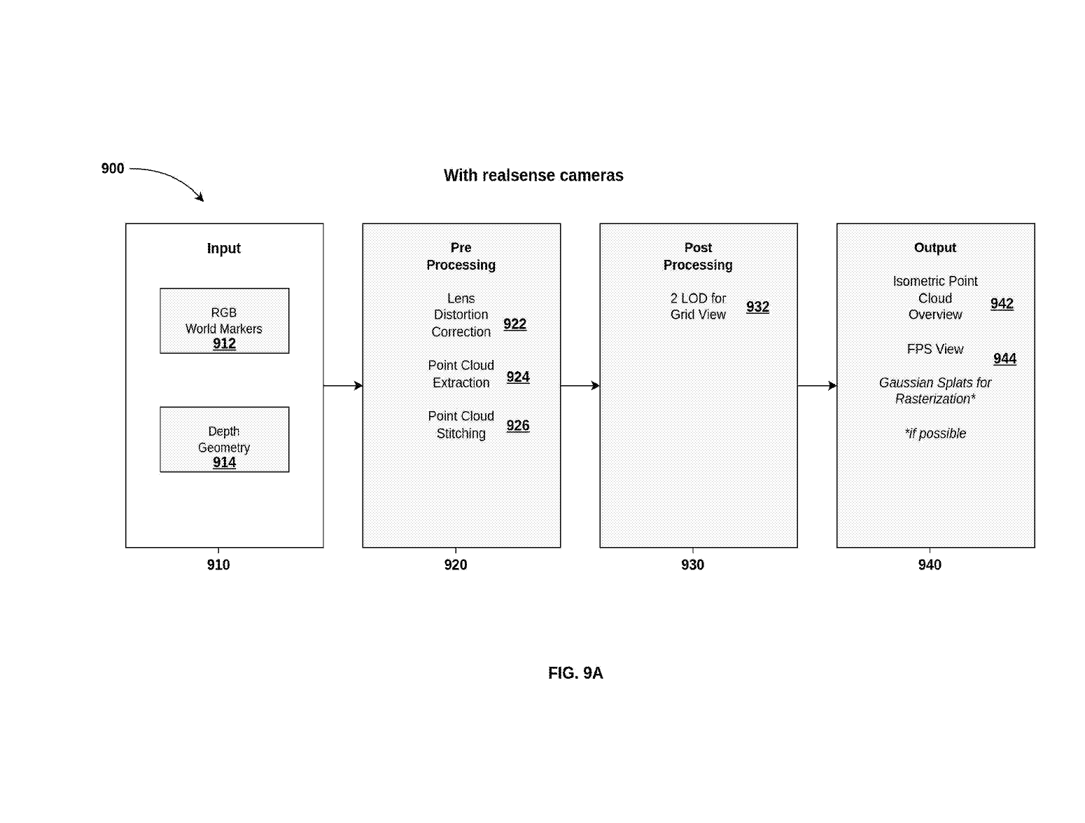

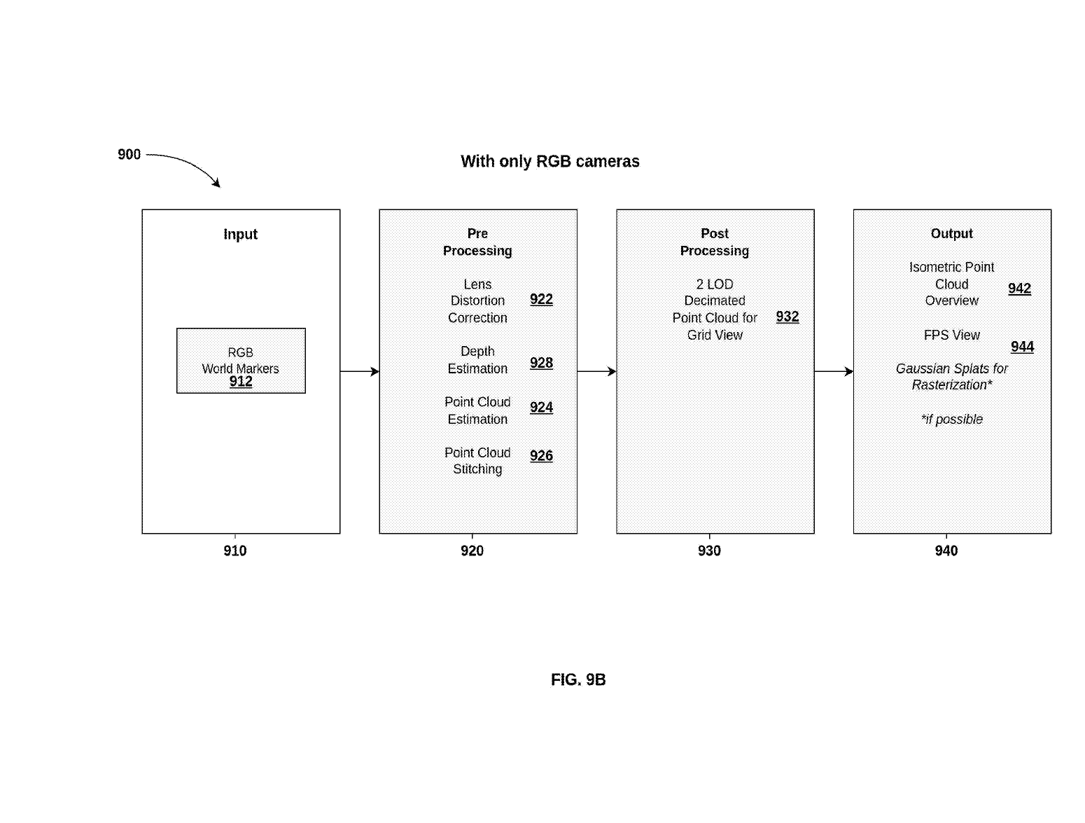

FIG. 9A and FIG. 9B illustrate camera processing pipelines for a camera processing system 900 according to aspects of the present disclosure. The camera processing system 900 may perform lens distortion correction, point cloud extraction, point cloud stitching, and depth estimation as pre-processing steps. The camera processing system 900 may generate multiple levels of detail including decimated point clouds for grid view and Gaussian splats for first-person view rasterization.

Referring to FIG. 9A, the camera processing system 900 may utilize cameras with depth sensing capability. In some aspects, the cameras with depth sensing capability may comprise RealSense cameras configured to capture both RGB image data and depth data.

The camera processing system 900 may include an input step 910. The input step 910 may receive RGB data with world markers 912. The RGB data with world markers 912 may include reference markers positioned within the physical facility for alignment purposes. The input step 910 may receive depth data representing geometry 914. The depth data representing geometry 914 may be captured directly by depth-sensing cameras and may represent three-dimensional geometry of the physical environment.

The camera processing system 900 may include a pre-processing step 920. The pre-processing step 920 may perform lens distortion correction 922 on the image data from the plurality of cameras. The lens distortion correction 922 may correct for optical distortions introduced by camera lenses to produce geometrically accurate image data. The pre-processing step 920 may perform point cloud extraction 924. The point cloud extraction 924 may extract point cloud data from the image data and the depth data. The pre-processing step 920 may perform point cloud stitching 926. The point cloud stitching 926 may combine point cloud segments from the plurality of cameras into a unified three-dimensional point cloud representation of the physical facility.

The camera processing system 900 may include a post-processing step 930. The post-processing step 930 may generate 2 LOD for grid view 932. The 2 LOD for grid view 932 may represent multiple levels of detail of the unified three-dimensional point cloud representation. A first level of detail may be generated for overview visualization and a second level of detail may be generated for detailed inspection.

The camera processing system 900 may include an output step 940. The output step 940 may produce an isometric point cloud overview 942. The isometric point cloud overview 942 may provide a three-dimensional overview visualization of the physical facility from an isometric perspective. The output step 940 may produce an FPS view with Gaussian splats for rasterization 944. The FPS view with Gaussian splats for rasterization 944 may enable first-person perspective rendering of the three-dimensional point cloud representation. The use of Gaussian splat rasterization may enable real-time navigation through the digital twin environment.

Referring to FIG. 9B, the camera processing system 900 may utilize RGB cameras without dedicated depth sensors. In some aspects, the security system 100 may use RGB cameras without dedicated depth sensors, wherein depth information may be derived using computational depth estimation techniques.

The input step 910 may receive RGB data with world markers 912. The RGB data with world markers 912 may include reference markers positioned within the physical facility for alignment purposes. In the configuration of FIG. 9B, the input step 910 may not receive dedicated depth data from the cameras.

The pre-processing step 920 may perform lens distortion correction 922 on the image data from the plurality of cameras. The pre-processing step 920 may perform depth estimation 928. The depth estimation 928 may derive depth information from the RGB image data using computational depth estimation techniques. The depth estimation 928 may enable generation of three-dimensional representations from cameras that do not include dedicated depth sensors. The pre-processing step 920 may perform point cloud extraction 924 based on the estimated depth information. The pre-processing step 920 may perform point cloud stitching 926 to combine point cloud segments from the plurality of cameras into a unified three-dimensional point cloud representation.

The post-processing step 930 may generate 2 LOD decimated point cloud for grid view 934. The 2 LOD decimated point cloud for grid view 934 may comprise a decimated point cloud with reduced point density for overview visualization. The decimated point cloud may reduce computational requirements for rendering the grid view while maintaining sufficient detail for security monitoring purposes.

The output step 940 may produce the isometric point cloud overview 942. The output step 940 may produce the FPS view with Gaussian splats for rasterization 944. The output step 940 may render the first-person perspective view in real-time to enable virtual navigation through the three-dimensional point cloud representation.

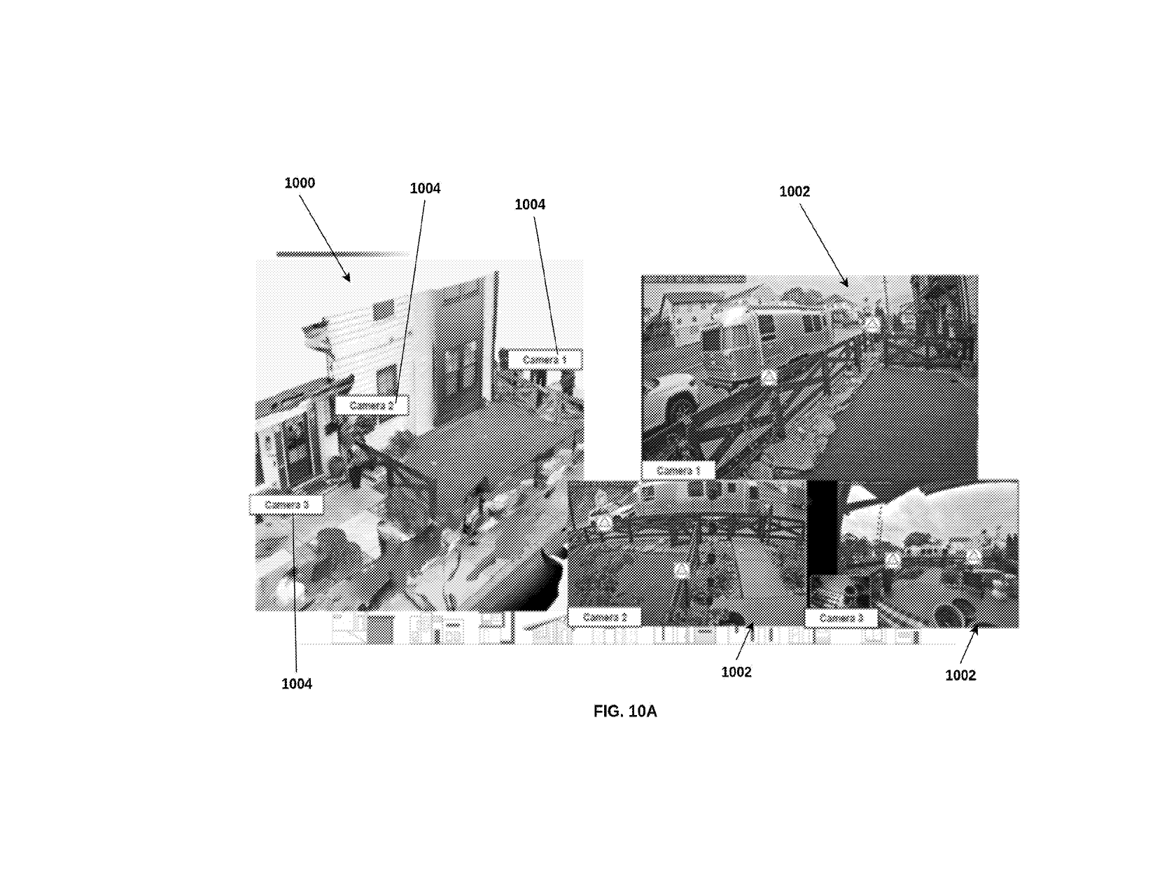

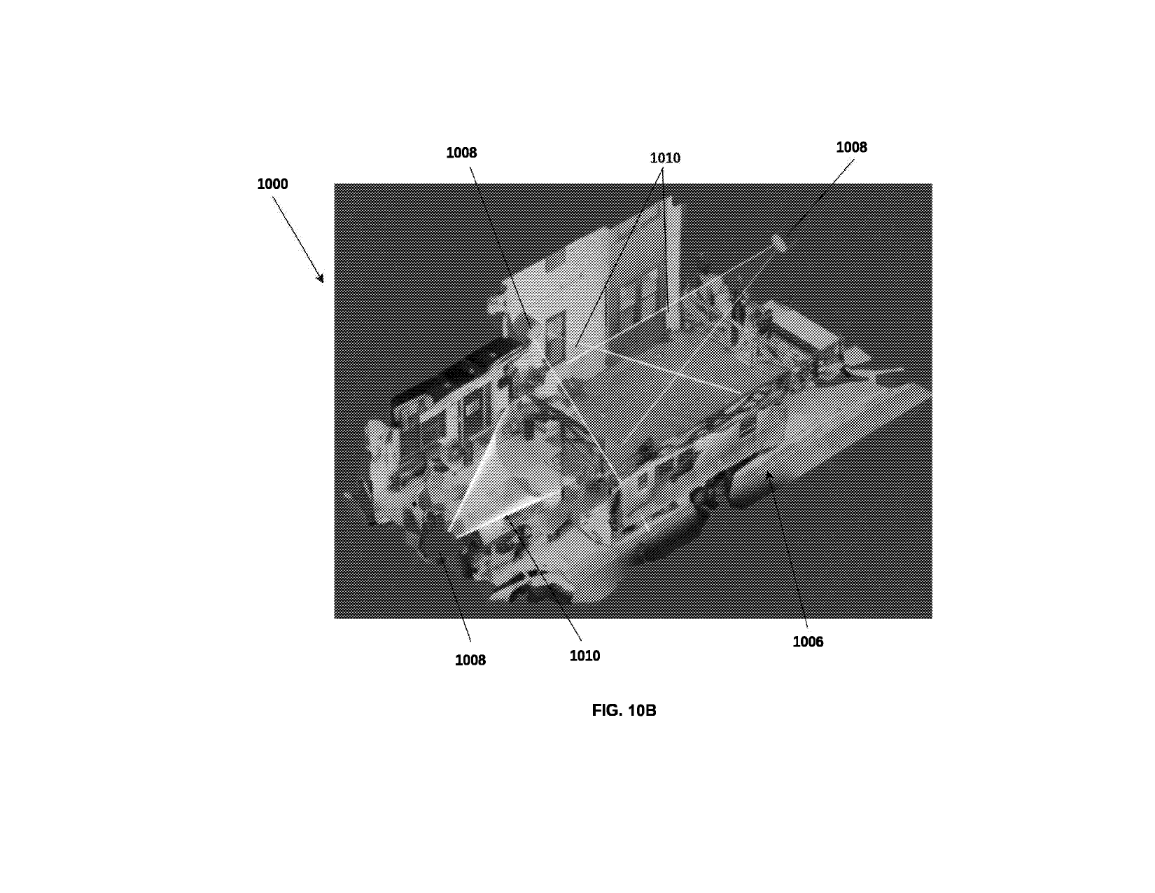

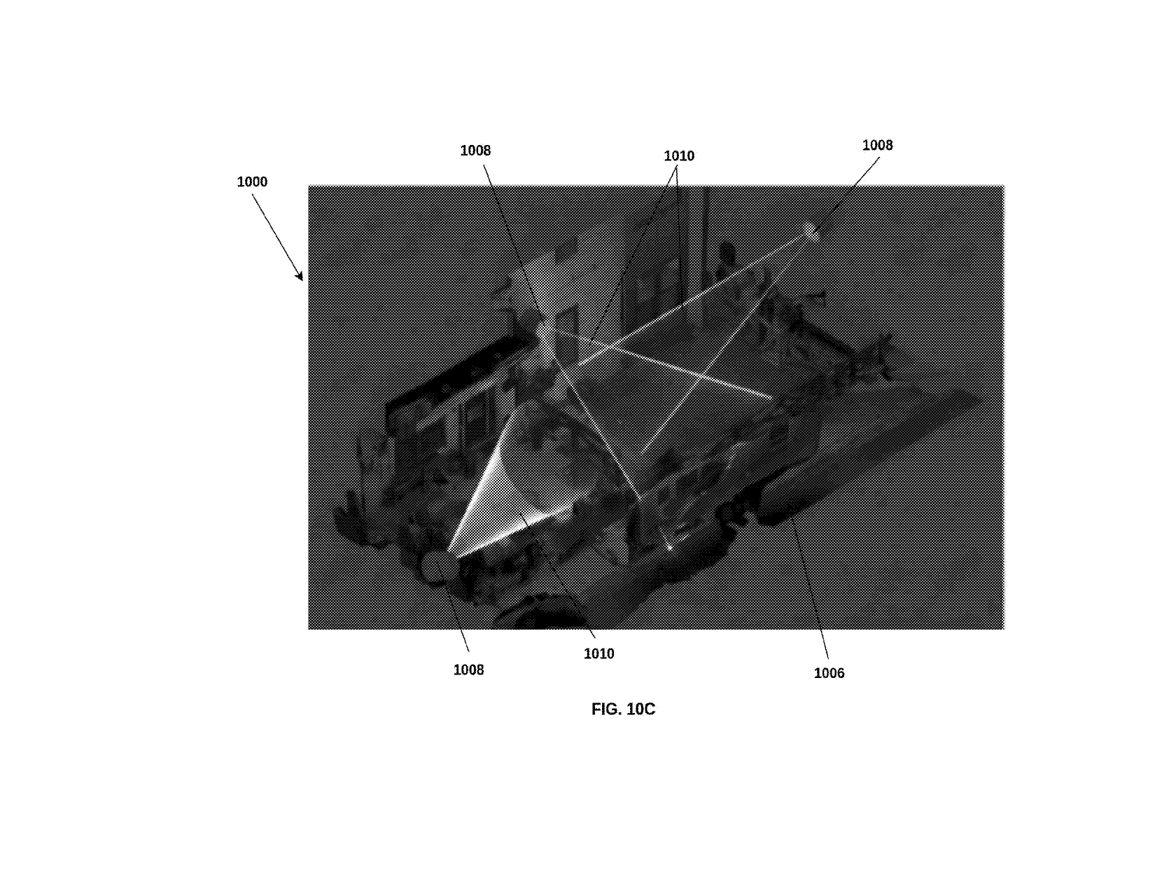

FIG. 10A, FIG. 10B, and FIG. 10C illustrate views of a 3D digital twin view 1000 according to aspects of the present disclosure. The 3D digital twin view 1000 may provide a multi-camera visualization system for displaying real-time video feeds and three-dimensional reconstructions of a physical facility.

Referring to FIG. 10A, the 3D digital twin view 1000 may include one or more camera view panels 1002. Each camera view panel 1002 may display a video feed from a corresponding camera positioned at a secured portal within the physical facility. Each camera view panel 1002 may be identified by a camera label 1004. The camera label 1004 may indicate a location or identifier of the corresponding camera within the physical facility. The camera view panels 1002 may be arranged in a grid or array configuration to enable security personnel to simultaneously monitor multiple areas within the physical facility.

As described above, a server may be linked to a plurality of smart lock devices via a communications network. The server may be configured to receive real-time video data and sensor data from the plurality of smart lock devices. The server may be configured to generate a three-dimensional spatial model of the physical facility based at least in part on the real-time video data. The server may be configured to stitch the real-time video data from the plurality of smart lock devices into the three-dimensional spatial model to generate an interactive digital twin.

A digital twin interface may be configured to display the interactive digital twin on a user device. The interactive digital twin may enable a user to virtually navigate through the physical facility in real-time by synchronizing physical door states, sensor readings, and video feeds within a unified three-dimensional visualization. The 3D digital twin view 1000 may provide the unified three-dimensional visualization that integrates the camera view panels 1002 with the three-dimensional spatial model.

Referring to FIG. 10B, the 3D digital twin view 1000 may include a point cloud model 1006. The point cloud model 1006 may show a three-dimensional reconstruction of a facility exterior. The point cloud model 1006 may be generated based on spatial data captured during an initial scanning and mapping process and real-time video data captured from the plurality of cameras distributed throughout the physical facility. The point cloud model 1006 may represent a daytime visualization of the physical facility, wherein ambient lighting conditions enable capture of detailed visual information.

The 3D digital twin view 1000 may include one or more camera position indicators 1008. Each camera position indicator 1008 may represent a location of a corresponding camera within the point cloud model 1006. The camera position indicators 1008 may enable security personnel to identify where cameras are positioned throughout the physical facility relative to the three-dimensional reconstruction.

The 3D digital twin view 1000 may include one or more camera field of view cones 1010. Each camera field of view cone 1010 may emanate from a corresponding camera position indicator 1008. The camera field of view cones 1010 may visually represent coverage areas of the corresponding cameras within the point cloud model 1006. The camera field of view cones 1010 may enable security personnel to identify which portions of the physical facility are within the field of view of corresponding cameras.

Referring to FIG. 10C, the 3D digital twin view 1000 may display a nighttime point cloud reconstruction of the same facility exterior as FIG. 10B. The point cloud model 1006 may be rendered with darker tones corresponding to reduced ambient lighting conditions. The camera position indicators 1008 and the camera field of view cones 1010 may remain visible within the nighttime visualization. The nighttime visualization may demonstrate the capability of the 3D digital twin view 1000 to maintain three-dimensional visualization under low-light conditions.

The digital twin interface may be further configured to overlay sensor data onto the interactive digital twin to display real-time sensor events within the physical facility. The 3D digital twin view 1000 may display sensor event data in conjunction with the point cloud model 1006, the camera position indicators 1008, and the camera field of view cones 1010. The combination of the point cloud model 1006, the camera position indicators 1008, and the camera field of view cones 1010 may provide comprehensive visualization of camera coverage and facility geometry within the interactive digital twin.

The 3D digital twin view 1000 may support both daytime and nighttime visualization modes. The daytime visualization mode may render the point cloud model 1006 with lighting conditions corresponding to daytime ambient lighting. The nighttime visualization mode may render the point cloud model 1006 with lighting conditions corresponding to nighttime ambient lighting. The ability to visualize the physical facility under different lighting conditions may enable security personnel to assess camera coverage and facility conditions regardless of time of day.

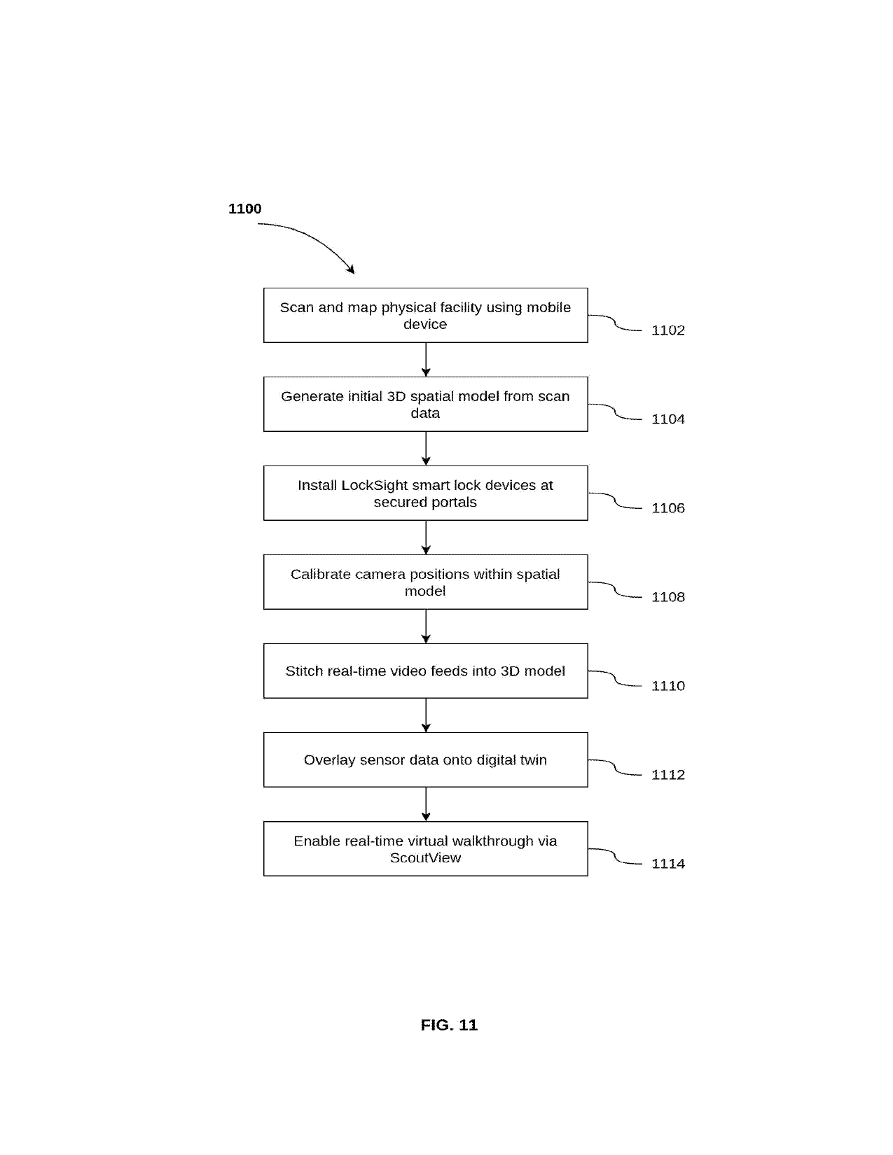

FIG. 11 illustrates a flowchart of a method 1100 for generating a digital twin environment of a physical facility according to aspects of the present disclosure. The method 1100 may be performed using the security system 100 described above.

The method 1100 may include a step 1102 of scanning and mapping the physical facility using a mobile scanning device. The mobile scanning device may be configured to scan and map the physical facility to generate spatial data representing a physical layout of the physical facility. In some aspects, a user may walk through the physical facility with the mobile scanning device to capture spatial data of the interior of the physical facility. The mobile scanning device may capture spatial data including dimensions, room configurations, doorway locations, and other physical features of the physical facility. The spatial data may be used to generate an initial three-dimensional spatial model of the physical facility.

The method 1100 may include a step 1104 of generating an initial three-dimensional spatial model of the physical facility based on the spatial data. The server 140 may receive the spatial data from the mobile scanning device and generate the initial three-dimensional spatial model. The initial three-dimensional spatial model may represent the physical layout of the physical facility including rooms, hallways, doorways, and other structural features.

The method 1100 may include a step 1106 of installing a plurality of cameras at locations distributed throughout the physical facility. In some aspects, the plurality of cameras may be integrated within smart lock devices positioned at secured portals throughout the physical facility. Each smart lock device may comprise a camera 180 configured to capture video data of at least one of an interior area or an exterior area adjacent to a corresponding secured portal, one or more sensors configured to capture sensor data, and a locking device 200 configured to selectively restrict movement of a door associated with the corresponding secured portal.

The method 1100 may include a step 1108 of calibrating positions of the plurality of cameras within the three-dimensional spatial model. Calibrating the positions of the plurality of cameras may include determining a location and orientation of each camera within the three-dimensional spatial model. The calibration may enable accurate alignment of real-time video data captured by each camera with corresponding locations within the three-dimensional spatial model. In some aspects, calibration may be performed using reference markers positioned within the physical facility.

The method 1100 may include a step 1110 of capturing real-time video data from the plurality of cameras and stitching the real-time video data from the plurality of cameras together. Each camera may capture real-time video data of a respective area within the physical facility. The digital twin interface 240 may receive the real-time video data from the plurality of cameras and stitch the real-time video data together to generate a unified video representation. The stitching process may combine video feeds from multiple cameras into a cohesive visualization that covers multiple areas of the physical facility.

The method 1100 may include a step 1112 of overlaying sensor data onto the interactive digital twin. The sensor data may include at least one of occupancy data, environmental condition data, or access event data. The digital twin interface 240 may overlay the sensor data onto the interactive digital twin to display real-time sensor events within the physical facility. The sensor data may be received from the one or more sensors integrated within the smart lock devices distributed throughout the physical facility. The overlaid sensor data may include intrusion detection data, fire detection data, or access status data.

The method 1100 may include a step 1114 of enabling real-time virtual navigation through the interactive digital twin via a user interface. The digital twin interface 240 may overlay the stitched real-time video data onto the three-dimensional spatial model to generate the interactive digital twin of the physical facility that mirrors real-time activity within the physical facility. The user device 120 may display the interactive digital twin such that a user may virtually navigate through the physical facility in real-time. In some aspects, enabling real-time virtual navigation may include displaying the interactive digital twin on at least one of an augmented reality device, a virtual reality device, a mobile device, or a desktop computer.

The method 1100 may enable security personnel and first responders to virtually navigate through the physical facility in real-time by synchronizing physical door states, sensor readings, and video feeds within a unified three-dimensional visualization. The interactive digital twin may provide real-time awareness of the interior of the physical facility and the conditions therein without requiring physical presence at the location.

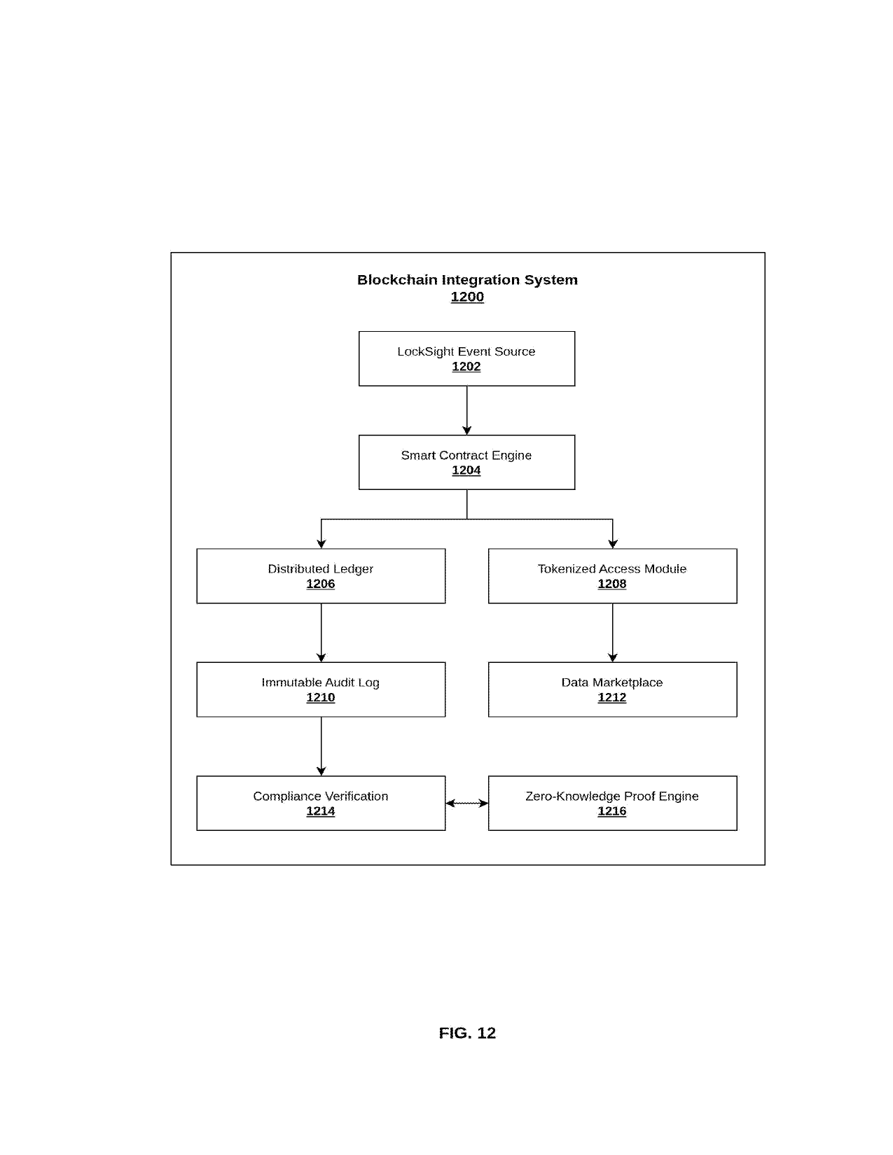

FIG. 12 illustrates a system diagram of a blockchain integration system 1200 according to aspects of the present disclosure. The blockchain integration system 1200 may provide trust infrastructure for access control and facility monitoring operations. As described above, access events may be logged to a distributed ledger via a blockchain integration module.

The blockchain integration system 1200 may include an event source 1202. The event source 1202 may be configured to transmit access events and sensor detections to other components of the blockchain integration system 1200. The event source 1202 may receive event data from one or more smart lock devices distributed at secured portals throughout a physical facility. The event data may include access events, door open events, door close events, sensor detections, and anomaly detections.

The blockchain integration system 1200 may include a smart contract engine 1204. The smart contract engine 1204 may be configured to receive access event data from the LockSight event source 1202. The smart contract engine 1204 may be configured to validate the access event data. The smart contract engine 1204 may be configured to write transaction records to a distributed ledger 1206. The smart contract engine 1204 may be configured to trigger blockchain entries when events occur, such as door breach events, system update events, or sensor failure events.

The blockchain integration system 1200 may include the distributed ledger 1206. The distributed ledger 1206 may be configured to store immutable records of access event data written by the smart contract engine 1204. The distributed ledger 1206 may maintain an immutable audit log 1210. The immutable audit log 1210 may be configured to record access events and sensor detections as immutable records on the distributed ledger 1206. The immutable audit log 1210 may use cryptographic techniques to provide audit trail integrity. In some aspects, the distributed ledger 1206 may be implemented as a private blockchain operating within an air-gapped network environment for secure deployments in military, energy, or defense applications.

The blockchain integration system 1200 may include a tokenized access module 1208. The tokenized access module 1208 may be configured to manage access permissions using cryptographic tokens. Each cryptographic token may represent time-based or role-based access rights to one or more secured portals. The tokenized access module 1208 may tokenize access permissions via smart contracts using non-fungible tokens to grant time-based or role-based entry permissions. The tokenized access module 1208 may issue non-fungible tokens or utility tokens representing access permissions. In some aspects, fire marshals, auditors, and vendors may gain temporary access rights via tokens issued by the tokenized access module 1208.

The blockchain integration system 1200 may include a data marketplace 1212. The data marketplace 1212 may be configured to enable monetization of anonymized sensor data or behavioral data through a decentralized marketplace. The data marketplace 1212 may use smart contracts to enforce usage rights and royalties for data access. Smart contract royalties may enforce usage rights for data accessed through the data marketplace 1212. In some aspects, researchers, facility operators, insurers, or defense contractors may purchase secure access to specific data streams through the data marketplace 1212. The data marketplace 1212 may provide royalties for reused models or predictive maintenance packages.

The blockchain integration system 1200 may include a compliance verification module 1214. The compliance verification module 1214 may be configured to generate regulatory compliance reports based on the immutable records stored on the distributed ledger 1206. The compliance verification module 1214 may provide compliance-as-a-service for regulated industries including hospitals, schools, and critical infrastructure with blockchain-backed audit trails. The compliance verification module 1214 may be configured to generate compliance reports for regulatory standards including HIPAA, FDA, DOE, and NERC requirements.

The blockchain integration system 1200 may include a zero-knowledge proof engine 1216. The zero-knowledge proof engine 1216 may be configured to generate cryptographic proofs based on the immutable records. Each cryptographic proof may verify a compliance condition without exposing underlying data contained in the immutable records. The zero-knowledge proof engine 1216 may enable verification of compliance with regulatory conditions without exposing underlying sensitive data. The blockchain integration system 1200 may record event logs using zero-knowledge proof techniques to maintain compliance with privacy standards including HIPAA and FDA conditions.

The blockchain integration system 1200 may provide blockchain-verified software licensing to prevent firmware spoofing and ensure authenticity of deployed software modules. The smart contract engine 1204 may use non-fungible tokens or smart contracts to represent licenses for software modules. The smart contract engine 1204 may ensure version control and usage tracking via chain activity. In some aspects, the smart contract engine 1204 may be configured to process micropayment transactions in conjunction with granting access, wherein the micropayment transactions are recorded on the distributed ledger 1206.

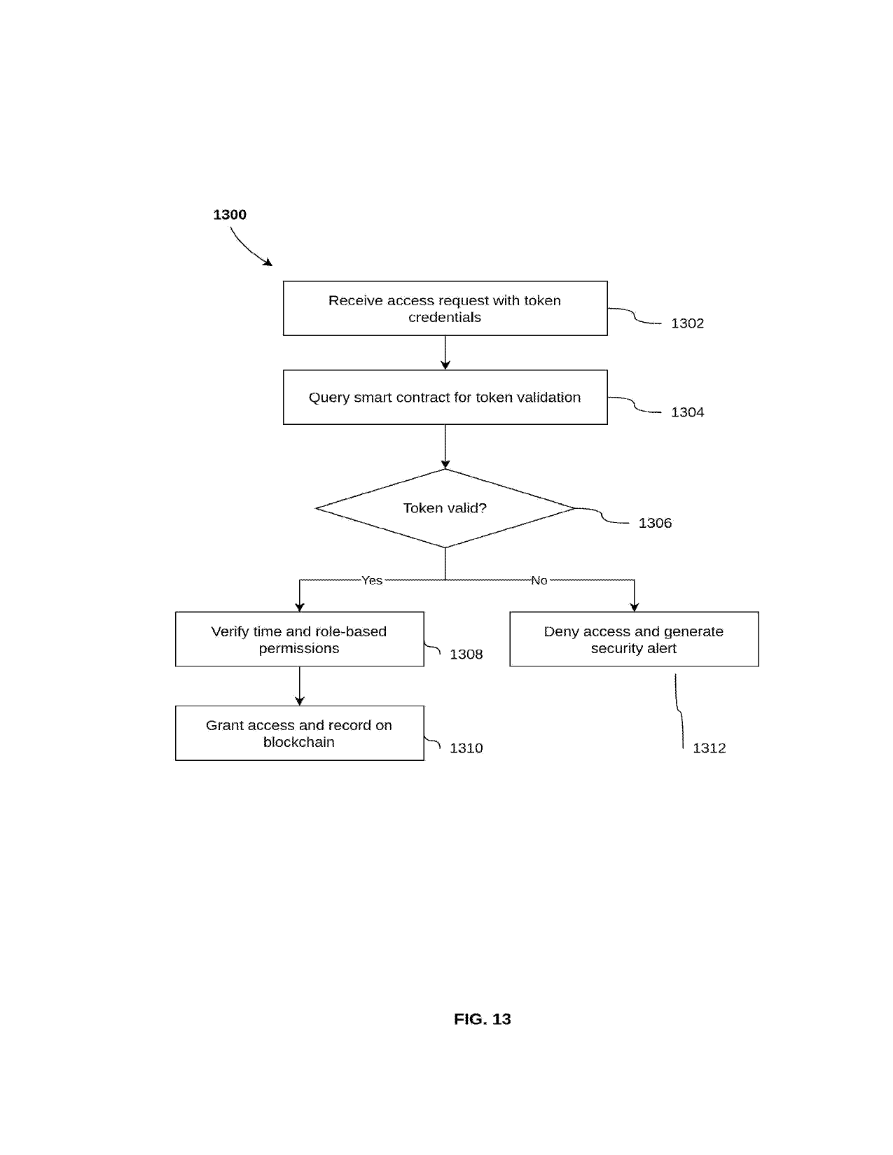

FIG. 13 illustrates a flowchart of a method 1300 for tokenized access control according to aspects of the present disclosure. The method 1300 may be performed using the blockchain integration system 1200 described above.

The method 1300 may include a step 1302 of receiving an access request with token credentials. The access request may be received from a user device or access control terminal at a secured portal. The token credentials may include a cryptographic token representing access permissions for one or more secured portals. The cryptographic token may be a non-fungible token or a utility token issued by the tokenized access module 1208. The token credentials may encode at least one of a time window during which access is permitted, a role designation, or a set of authorized secured portals.

The method 1300 may include a step 1304 of querying a smart contract for token validation. The smart contract engine 1204 may receive the token credentials from the access request. The smart contract engine 1204 may query the distributed ledger 1206 to verify authenticity of the cryptographic token. The smart contract engine 1204 may verify that the cryptographic token has not been revoked or invalidated. The smart contract engine 1204 may verify that the cryptographic token corresponds to a valid access permission record stored on the distributed ledger 1206.

The method 1300 may include a decision 1306 of determining whether the token is valid. The smart contract engine 1204 may evaluate the token credentials against validation criteria stored on the distributed ledger 1206. The validation criteria may include verification that the cryptographic token is authentic, has not expired, and has not been revoked. If the token is determined to be valid, the method 1300 may proceed to step 1308. If the token is determined to be invalid, the method 1300 may proceed to step 1312.

The method 1300 may include a step 1308 of verifying time and role-based permissions. The smart contract engine 1204 may verify that a current time falls within a time window encoded in the cryptographic token. The smart contract engine 1204 may verify that a role designation encoded in the cryptographic token authorizes access to the secured portal associated with the access request. The smart contract engine 1204 may verify that the secured portal is included in a set of authorized secured portals encoded in the cryptographic token. In some aspects, fire marshals, auditors, and vendors may gain temporary access rights via tokens that encode time-limited access periods.

The method 1300 may include a step 1310 of granting access and recording the event on the blockchain. The smart contract engine 1204 may generate an access grant signal to the locking device 200 associated with the secured portal. The locking device 200 may transition from a locked configuration to an unlocked configuration in response to receiving the access grant signal. The smart contract engine 1204 may write an access event record to the distributed ledger 1206. The access event record may include at least one of a timestamp, an identifier of the cryptographic token, an identifier of the secured portal, or an identifier of the user associated with the access request. The access event record may be stored as an immutable record on the distributed ledger 1206.

If the token is determined to be invalid at decision 1306, the method 1300 may include a step 1312 of denying access and generating a security alert. The smart contract engine 1204 may generate an access denial signal. The locking device 200 may remain in the locked configuration in response to the access denial. The smart contract engine 1204 may generate a security alert indicating an unauthorized access attempt. The security alert may be transmitted to a server 140 or user device 120 for review by security personnel. The smart contract engine 1204 may write an access denial record to the distributed ledger 1206 as an immutable record of the unauthorized access attempt.

The blockchain integration module 250 may support pay-per-use billing based on metrics including access duration, data analysis frequency, or digital twin interaction time. In some aspects, the smart contract engine 1204 may process micropayment transactions in conjunction with granting access. The micropayment transactions may be recorded on the distributed ledger 1206. The pay-per-use billing may enable tiered access models wherein different access levels correspond to different billing rates.

The security system 100 may support smart insurance partnerships wherein the blockchain integration module 250 provides audit data, anonymized sensor data, or compliance verification data to insurance underwriters. In some aspects, insurance underwriters may offer insurance premium discounts to facility operators in exchange for access to immutable audit logs, access event data, or environmental monitoring data stored on the distributed ledger. The compliance verification module 1214 may generate compliance reports or risk assessment data that insurance underwriters may use for policy adjustments or claims processing. In some aspects, the data marketplace 1212 may enable facility operators to share anonymized sensor data or behavioral data with insurance partners via smart contracts that enforce usage rights and data access permissions. The smart insurance partnerships may enable facility operators to reduce insurance costs while providing insurance underwriters with verified security and compliance data for risk assessment purposes.

The security system 100 may include a DAO governance module 258 that allows stakeholders to vote on platform development priorities or alarm response protocols using governance tokens. The DAO governance module 258 may issue and manage governance tokens. Each governance token may represent voting rights within a decentralized governance system. Stakeholders including schools, first responders, insurers, or facility operators may receive governance tokens. The governance tokens may enable stakeholders to vote on modifications to alarm routing protocols that determine how security alerts are distributed among first responders, facility operators, and emergency services.

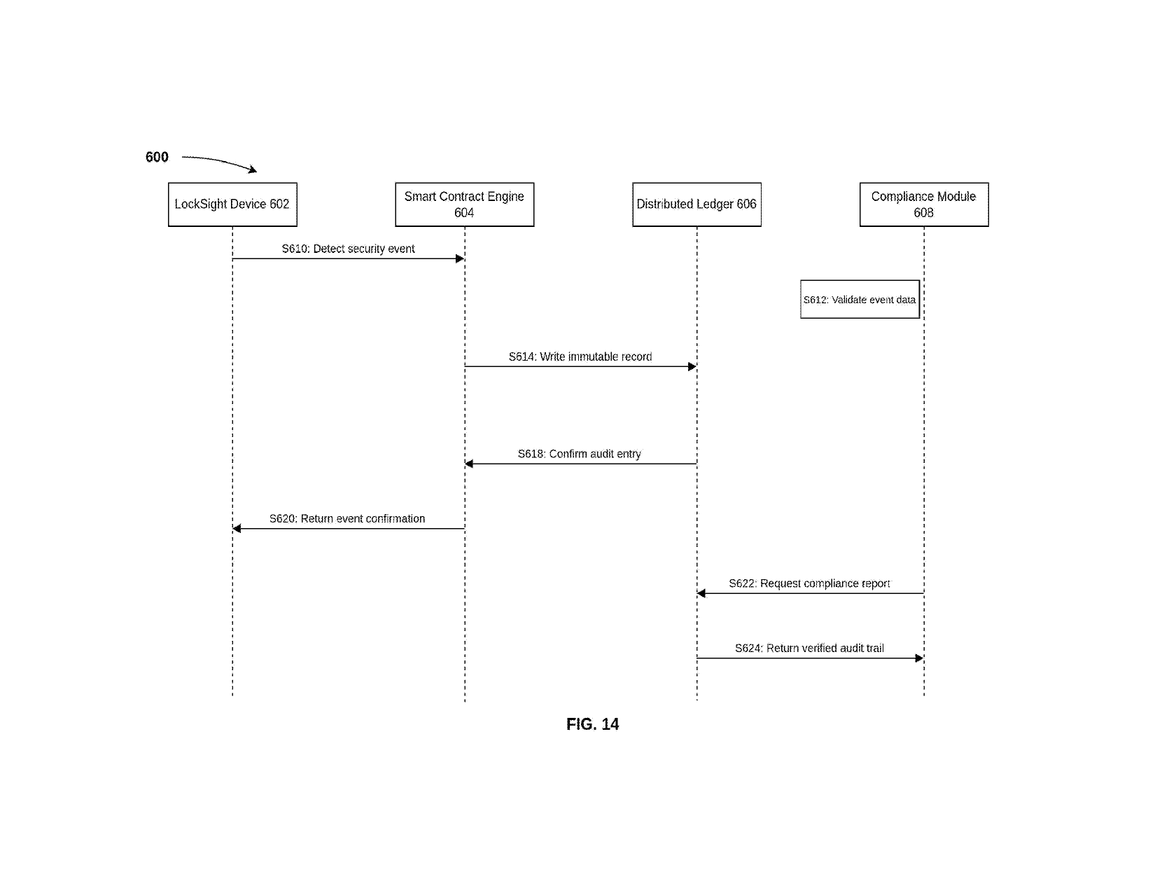

FIG. 14 illustrates a sequence diagram of a method 600 for immutable audit logging according to aspects of the present disclosure. The method 600 may involve a smart lock device 602, a smart contract engine 604, a distributed ledger 606, and a compliance module 608. The method 600 may be performed using the blockchain integration system 1200 described above.

In a step S610, the smart lock device 602 may detect a security event and transmit event data to the smart contract engine 604. The security event may include at least one of an access event, a door open event, a door close event, a sensor detection, or an anomaly detection. The event data may include at least one of a timestamp, an identifier of the smart lock device 602, an identifier of a secured portal, sensor readings, or video data associated with the security event.

In a step S612, the smart contract engine 604 may validate the event data received from the smart lock device 602. The smart contract engine 604 may verify authenticity of the event data by confirming that the event data originated from an authorized smart lock device 602. The smart contract engine 604 may verify integrity of the event data by confirming that the event data has not been modified during transmission. The smart contract engine 604 may verify completeness of the event data by confirming that the event data includes required fields for the corresponding event type.

In a step S614, the smart contract engine 604 may write an immutable record to the distributed ledger 606. The immutable record may include the validated event data. The immutable record may be stored as a transaction on the distributed ledger 606 such that the immutable record may not be modified or deleted after being written. The smart contract engine 604 may use cryptographic techniques to generate a hash of the event data and store the hash on the distributed ledger 606.

In some aspects, the distributed ledger 606 may be implemented using a Polygon blockchain or an Avalanche blockchain. The Polygon blockchain and the Avalanche blockchain may provide low transaction fees and high transaction throughput for processing security events from multiple smart lock devices 602 distributed throughout a physical facility. In some aspects, large data associated with the security event, such as three-dimensional model data or camera snapshots, may be stored using decentralized storage protocols including InterPlanetary File System (IPFS) or Arweave. The distributed ledger 606 may store a reference to the data stored on the decentralized storage protocols.

In some aspects, the smart contract engine 604 may implement smart contracts using Solidity programming language. The smart contracts may define rules for validating event data, writing immutable records, and generating cryptographic proofs. The smart contract engine 604 may use oracles for real-time synchronization between physical events detected by the smart lock device 602 and blockchain records stored on the distributed ledger 606. In some aspects, the oracles may include Chainlink oracles configured to provide real-time data feeds to the smart contracts.

In a step S616, the distributed ledger 606 may generate a zero-knowledge proof based on the immutable record. The zero-knowledge proof may verify a compliance condition without exposing underlying data contained in the immutable record. The zero-knowledge proof may enable verification that a security event occurred and was properly logged without revealing sensitive details of the security event. The zero-knowledge proof may maintain compliance with privacy standards including Health Insurance Portability and Accountability Act (HIPAA) and Food and Drug Administration (FDA) conditions.

In a step S618, the distributed ledger 606 may confirm the audit entry to the smart contract engine 604. The confirmation may include a transaction identifier corresponding to the immutable record stored on the distributed ledger 606. The confirmation may include a block number indicating a position of the immutable record within the distributed ledger 606.

In a step S620, the smart contract engine 604 may return an event confirmation to the smart lock device 602. The event confirmation may indicate that the security event has been successfully logged to the distributed ledger 606. The event confirmation may include the transaction identifier and the block number for reference purposes.

In a step S622, the compliance module 608 may request a compliance report from the distributed ledger 606. The compliance report request may specify a time period, a set of secured portals, or a set of compliance conditions for which the compliance report is requested. The compliance module 608 may receive the compliance report request from an auditor or regulatory authority.

In a step S624, the distributed ledger 606 may return a verified audit trail to the compliance module 608. The verified audit trail may include immutable records corresponding to the compliance report request. The verified audit trail may include zero-knowledge proofs that verify compliance conditions without exposing underlying sensitive data. The compliance module 608 may generate a compliance report based on the verified audit trail for regulatory standards including HIPAA, FDA, Department of Energy (DOE), or North American Electric Reliability Corporation (NERC) conditions.

In some aspects, the security system 100 may provide wallet access through Metamask integration. The Metamask integration may enable secure login and token access to the platform. Users may authenticate using cryptographic credentials stored in a Metamask wallet. The Metamask wallet may store cryptographic tokens representing access permissions or governance rights within the security system 100.

The method 600 may enable compliance-as-a-service for regulated industries including hospitals, schools, and facilities housing equipment associated with power generation or distribution. The method 600 may provide certification services backed by blockchain audit trails. The immutable audit logging provided by the method 600 may enable organizations to demonstrate compliance with regulatory conditions without exposing sensitive operational data.

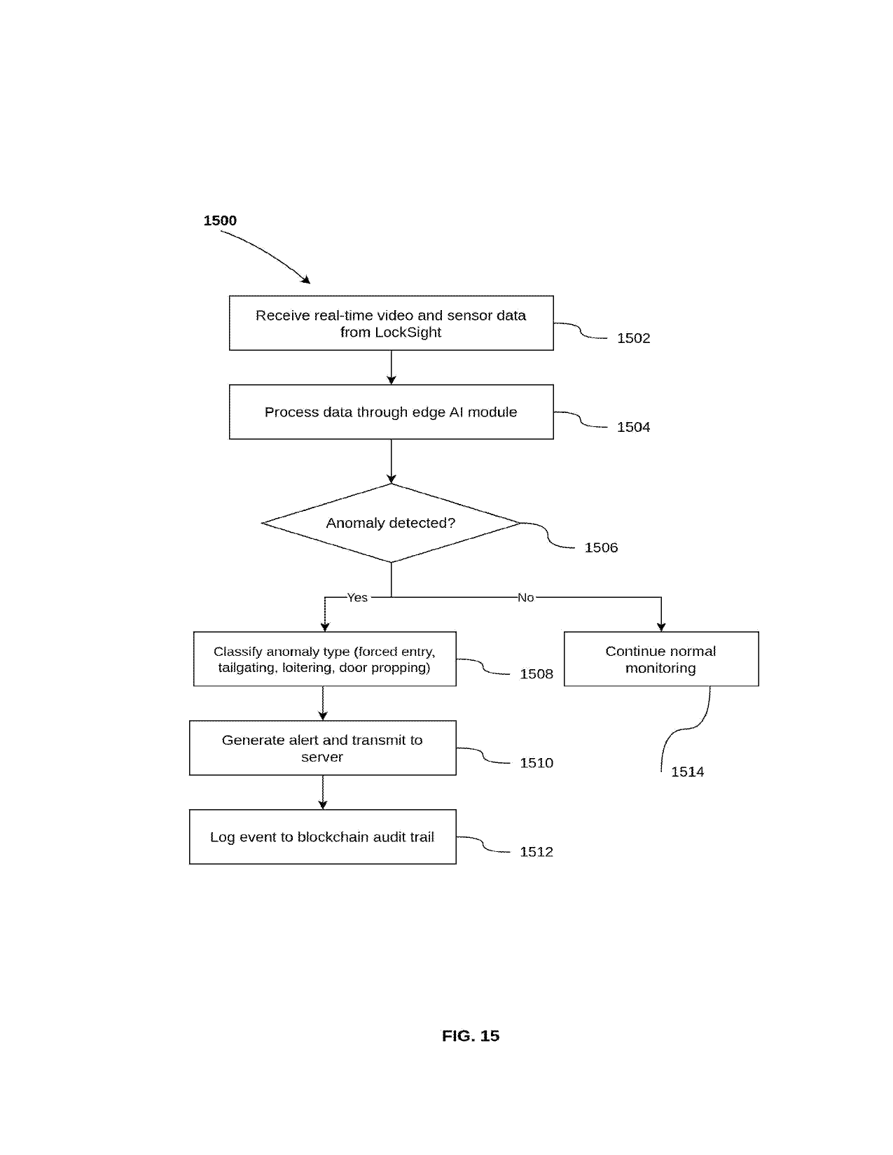

FIG. 15 illustrates a flowchart of a method 1500 for edge AI anomaly detection according to aspects of the present disclosure. The method 1500 may be performed using the security system 100 described above. As described above, the server 140 may employ artificial intelligence and machine learning to detect a threat within the physical facility based on the real-time video data and the sensor data.

The method 1500 may include a step 1502 of receiving real-time video and sensor data from a smart lock device. The smart lock device may capture real-time video data via a camera 180 integrated within a housing 152 of the smart lock device. The smart lock device may capture sensor data via one or more sensors integrated within the housing 152. The one or more sensors may include at least one of a force detector sensor 155, an occupancy sensor 160, a smoke/fire/heat sensor 165, a door position sensor 184, a motion sensor, or a tamper sensor. The real-time video data and the sensor data may be received by an edge AI module 210 integrated within the smart lock device.

The method 1500 may include a step 1504 of processing the real-time video data and the sensor data through the edge AI module 210. The edge AI module 210 may process the real-time video data and the sensor data locally at the smart lock device without transmitting all video data to a remote server for processing. The edge AI module 210 may perform object detection and person detection on the real-time video data using machine learning models stored in memory of the edge AI module 210. The edge AI module 210 may correlate the real-time video data with the sensor data received from the one or more sensors to identify patterns indicative of security anomalies.

The method 1500 may include a decision 1506 of determining whether an anomaly is detected. The edge AI module 210 may compare processed data against predefined anomaly detection criteria. The anomaly detection criteria may include thresholds, patterns, or behavioral indicators associated with security anomalies. If an anomaly is detected, the method 1500 may proceed to step 1508. If no anomaly is detected, the method 1500 may proceed to step 1514.

The method 1500 may include a step 1508 of classifying an anomaly type in response to detecting an anomaly at decision 1506. The edge AI module 210 may classify the detected anomaly into anomaly categories. The anomaly categories may include forced entry, tailgating, unauthorized loitering, and door propping. The edge AI module 210 may classify forced entry based on correlation of force detector sensor data indicating physical impact with video analysis indicating unauthorized presence at a secured portal. The edge AI module 210 may classify tailgating by identifying multiple individuals passing through the secured portal during a single authorized access event based on person detection within the real-time video data. The edge AI module 210 may classify unauthorized loitering based on detection of an individual remaining within a camera field of view for a duration exceeding a configurable threshold time period. The edge AI module 210 may classify door propping based on door position sensor data indicating a door remains in an open position for a duration exceeding a configurable threshold time period.

The method 1500 may include a step 1510 of generating an alert and transmitting the alert to the server 140 in response to classifying the anomaly type at step 1508. The alert may include information identifying the anomaly type, a timestamp, an identifier of the smart lock device, and an identifier of the secured portal at which the anomaly was detected. The alert may be transmitted to the server 140 via the communications network 130. The server 140 may relay the alert to one or more user devices 120 for review by security personnel. In some aspects, the system may be configured to trigger a locking function to simultaneously lock a plurality of locking devices 200 associated with a plurality of smart lock devices in response to detecting a threat.

The method 1500 may include a step 1512 of logging the event to a blockchain audit trail in response to generating the alert at step 1510. The blockchain integration module 250 may receive event data from the edge AI module 210 or the server 140. The blockchain integration module 250 may write an immutable record of the detected anomaly to the distributed ledger. The immutable record may include the anomaly type, the timestamp, the identifier of the smart lock device, the identifier of the secured portal, and sensor readings associated with the detected anomaly. The immutable audit log 252 may store the immutable record using cryptographic techniques to provide audit trail integrity.

If no anomaly is detected at decision 1506, the method 1500 may include a step 1514 of continuing normal monitoring. The edge AI module 210 may continue to receive and process real-time video data and sensor data from the smart lock device. The method 1500 may return to step 1502 to receive additional real-time video and sensor data. The edge AI module 210 may continuously monitor for anomalies without interruption during normal monitoring operations.

The edge AI module 210 may be configured to update machine learning models based on model updates received from the server 140 without interrupting anomaly detection operations. The model updates may include updated anomaly detection criteria, updated classification parameters, or updated machine learning model weights. The edge AI module 210 may apply the model updates to improve anomaly detection accuracy over time.

The security system 100 may support application programming interface (API) licensing with per-door API access pricing for platform partners and third-party integrations. Platform partners may access anomaly detection data and alert data via the API. The per-door API access pricing may enable platform partners to integrate anomaly detection capabilities into third-party software applications on a per-door basis.

The security system 100 may provide white-labeled or co-branded deployment options for enterprise accounts and regulated verticals. Enterprise accounts may deploy the security system 100 with customized branding and user interface configurations. In some aspects, the security system 100 may be bundled with existing enterprise accounts from access control platform providers. Platform partners may access the security system 100 via per-door API licensing arrangements, enabling integration of the security system 100 capabilities into third-party access control platforms. Regulated verticals including schools, utilities, and government facilities may deploy the security system 100 with co-branded configurations that comply with sector-specific requirements.

The security system 100 may support rapid deployable access control configurations for Department of Defense and commercial applications. The rapid deployable configurations may include pre-configured smart lock devices and portable server equipment that may be deployed quickly to temporary or mobile facilities. The rapid deployable configurations may enable establishment of secure access control within hours rather than days or weeks.

The security system 100 may include satellite connectivity options for remote or mobile deployments. The server 140 may be configured to communicate via satellite communication interfaces for locations without terrestrial network connectivity. In some aspects, the satellite connectivity may include integration with satellite communication services for global coverage. The satellite connectivity may enable deployment of the security system 100 in remote locations, disaster response scenarios, or mobile command facilities where traditional network infrastructure is unavailable.

The security system 100 may include an upgradable sensor platform architecture. The upgradable sensor platform architecture may enable addition of new sensor types to the smart lock devices as sensor technologies evolve. The controller 150 may be configured to receive and process data from sensor types that were not available at the time of initial deployment. The upgradable sensor platform architecture may extend the useful life of the security system 100 by enabling incorporation of future sensor technologies without replacement of the smart lock devices.

The following exemplary embodiments describe additional aspects of the present disclosure. These exemplary embodiments are provided to illustrate the breadth of the inventive concepts and are not intended to limit the scope of the claims.

### Exemplary Embodiment 1 – Blockchain-Based Access Control System

According to an exemplary embodiment, a security system comprising a blockchain-based access control system for a physical facility, the system comprises: a plurality of smart lock devices distributed at secured portals throughout the physical facility, each smart lock device comprising a locking device configured to selectively restrict movement of a door and one or more sensors configured to detect access events; a smart contract engine configured to receive access event data from the plurality of smart lock devices and validate the access event data; a distributed ledger configured to store immutable records of the access event data written by the smart contract engine; a tokenized access module configured to manage access permissions using cryptographic tokens, wherein each cryptographic token represents time-based or role-based access rights to one or more secured portals; and a compliance verification module configured to generate regulatory compliance reports based on the immutable records stored on the distributed ledger.

In some aspects, the tokenized access module is configured to issue non-fungible tokens representing access permissions, wherein each non-fungible token encodes at least one of a time window during which access is permitted, a role designation, or a set of authorized secured portals.

In some aspects, the system further comprises a zero-knowledge proof engine configured to generate cryptographic proofs that verify compliance with regulatory conditions without exposing underlying access event data.

In some aspects, the smart contract engine is configured to process micropayment transactions in conjunction with granting access, wherein the micropayment transactions are recorded on the distributed ledger.

In some aspects, the compliance verification module is configured to generate compliance reports for at least one of HIPAA, FDA, DOE, or NERC regulatory standards.

In some aspects, the distributed ledger is implemented as a private blockchain operating within an air-gapped network environment.

In some aspects, the smart contract engine is configured to revoke access permissions by invalidating corresponding cryptographic tokens on the distributed ledger in response to detecting a security anomaly.

### Exemplary Embodiment 2 – Edge AI Anomaly Detection System

According to an exemplary embodiment, a security system comprising an edge-based anomaly detection system, the system comprises: a smart lock device positioned at a secured portal, the smart lock device comprising a camera configured to capture real-time video data, a force detector sensor configured to detect physical impact on the secured portal, a door position sensor configured to detect door state, and a locking device configured to selectively restrict movement of a door; an edge AI module integrated within the smart lock device, the edge AI module comprising a processor and memory storing machine learning models, wherein the edge AI module is configured to process the real-time video data and sensor data locally at the smart lock device to detect security anomalies without transmitting the real-time video data to a remote server; and an alert generation module configured to generate and transmit security alerts to a server in response to the edge AI module detecting a security anomaly.

In some aspects, the edge AI module is configured to classify detected security anomalies into anomaly categories comprising forced entry, tailgating, loitering, and door propping.

In some aspects, the edge AI module is configured to detect forced entry based on correlation of force detector sensor data indicating physical impact with video analysis indicating unauthorized presence at the secured portal.

In some aspects, the edge AI module is configured to detect tailgating by identifying multiple individuals passing through the secured portal during a single authorized access event based on person detection within the real-time video data.

In some aspects, the edge AI module is configured to detect door propping based on door position sensor data indicating the door remains in an open position for a duration exceeding a configurable threshold time period.

In some aspects, the smart lock device further comprises a multi-sensor fusion module configured to combine data from the camera, the force detector sensor, the door position sensor, and one or more environmental sensors to provide input data to the edge AI module.

In some aspects, the edge AI module is configured to update the machine learning models based on model updates received from the server without interrupting anomaly detection operations.

### Exemplary Embodiment 3 – Smart Lock Device with Integrated Multi-Sensor Array

According to an exemplary embodiment, a security system comprising a smart lock device for installation at a secured portal, the smart lock device comprises: a housing configured for mounting at an upper portion of a door assembly; a bidirectional camera module mounted within the housing, the bidirectional camera module comprising a first lens directed toward an interior of a room and a second lens directed toward an exterior area adjacent to the secured portal; a multi-sensor fusion module mounted within the housing, the multi-sensor fusion module configured to integrate data from a motion sensor, a tamper sensor, a temperature sensor, and an occupancy sensor; a door position sensor configured to detect door open and door close events; a locking device configured to selectively restrict movement of a door associated with the secured portal; a controller configured to receive sensor data from the multi-sensor fusion module and the door position sensor, process the sensor data, and generate control signals for the locking device; and a Power-over-Ethernet interface configured to receive power and data through a single network connection.

In some aspects, the smart lock device further comprises a request-to-exit motion detector configured to detect motion within a sensor field of view directed toward a door handle, wherein the controller is configured to place the locking device in an unlocked configuration in response to the request-to-exit motion detector detecting motion.

In some aspects, the housing comprises a fire-rated enclosure providing fire protection for internal components of the smart lock device.

In some aspects, the smart lock device further comprises a battery positioned within the housing, the battery configured to provide backup power to the smart lock device during interruption of power from the Power-over-Ethernet interface.

In some aspects, the controller comprises an edge AI module configured to perform object detection and person detection using artificial intelligence on video data captured by the bidirectional camera module.

In some aspects, the smart lock device further comprises a smoke sensor and an air quality sensor integrated within the housing, wherein the multi-sensor fusion module is configured to integrate data from the smoke sensor and the air quality sensor with data from the motion sensor, the tamper sensor, the temperature sensor, and the occupancy sensor.

### Exemplary Embodiment 4 – Camera Processing System for 3D Point Cloud Generation

According to an exemplary embodiment, a security system comprising a camera processing system for generating three-dimensional representations of a physical facility, the camera processing system comprises: a plurality of cameras distributed throughout the physical facility, each camera configured to capture image data of a respective area within the physical facility; a pre-processing module configured to perform lens distortion correction on the image data from the plurality of cameras and extract point cloud data from the image data; a point cloud stitching module configured to combine point cloud segments from the plurality of cameras into a unified three-dimensional point cloud representation of the physical facility; a post-processing module configured to generate multiple levels of detail of the unified three-dimensional point cloud representation; and an output module configured to generate an isometric point cloud overview and a first-person perspective view using Gaussian splat rasterization based on the unified three-dimensional point cloud representation.

In some aspects, the plurality of cameras comprise depth-sensing cameras, and wherein the pre-processing module is configured to extract the point cloud data based on depth data captured by the depth-sensing cameras.

In some aspects, the plurality of cameras comprise RGB cameras without dedicated depth sensors, and wherein the pre-processing module further comprises a depth estimation module configured to derive depth information from the image data using computational depth estimation techniques.

In some aspects, the point cloud stitching module is configured to align point cloud segments from the plurality of cameras based on reference markers positioned within the physical facility.

In some aspects, the post-processing module is configured to generate a first level of detail for overview visualization and a second level of detail for detailed inspection, wherein the first level of detail comprises a decimated point cloud with reduced point density.

In some aspects, the output module is configured to render the first-person perspective view in real-time to enable virtual navigation through the three-dimensional point cloud representation.

### Exemplary Embodiment 5 – First Responder Situational Awareness System

According to an exemplary embodiment, a security system comprising a first responder situational awareness system, the system comprises: a plurality of smart lock devices distributed at secured portals throughout a physical facility, each smart lock device comprising a camera configured to capture real-time video data, an occupancy sensor configured to detect presence of occupants, and a locking device; a server configured to receive the real-time video data and occupancy data from the plurality of smart lock devices and generate a digital representation of the physical facility; a threat detection module configured to detect and track a location of a threat within the physical facility based on the real-time video data; a route calculation module configured to calculate a first responder navigation route from an entry point of the physical facility to the detected location of the threat; a safe zone identification module configured to identify rooms within the physical facility that are verified as secure based on lock status and occupancy data; and a user interface configured to display the digital representation of the physical facility with overlays indicating the location of the threat, the first responder navigation route, and the identified safe zones.

In some aspects, the user interface is configured to display real-time video feeds from the plurality of smart lock devices adjacent to the digital representation of the physical facility.

In some aspects, the threat detection module is configured to generate identification information for a detected threat, the identification information comprising at least one of height, clothing description, or armed status.

In some aspects, the system further comprises an emergency services notification module configured to automatically transmit alert data to emergency services in response to the threat detection module detecting a threat, wherein the alert data comprises the location of the threat within the physical facility.

In some aspects, the user interface is accessible remotely by first responder personnel via at least one of a mobile device, a tablet, or a vehicle-mounted display.

In some aspects, the safe zone identification module is configured to update safe zone designations in real-time based on changes in lock status and occupancy data received from the plurality of smart lock devices.

### Exemplary Embodiment 6 – Compliance Verification System with Zero-Knowledge Proofs

According to an exemplary embodiment, a security system comprising a compliance verification system for a secured facility, the system comprises: a plurality of sensors distributed throughout the secured facility, the plurality of sensors configured to capture access event data and environmental condition data; a distributed ledger configured to store immutable records of the access event data and the environmental condition data; a zero-knowledge proof engine configured to generate cryptographic proofs based on the immutable records, wherein each cryptographic proof verifies a compliance condition without exposing underlying data contained in the immutable records; a compliance verification module configured to receive audit requests specifying compliance conditions and invoke the zero-knowledge proof engine to generate corresponding cryptographic proofs; and an audit interface configured to provide the cryptographic proofs to auditors in response to the audit requests.

In some aspects, the compliance verification module is configured to generate compliance reports for HIPAA regulatory conditions, wherein the zero-knowledge proof engine generates cryptographic proofs verifying access controls for protected health information without exposing patient data.

In some aspects, the compliance verification module is configured to generate compliance reports for NERC regulatory conditions for power facility security, wherein the zero-knowledge proof engine generates cryptographic proofs verifying physical access controls and environmental monitoring without exposing operational data.

In some aspects, the audit interface is configured to provide remote access to auditors via tokenized access permissions, wherein each tokenized access permission grants time-limited access to request cryptographic proofs for specified compliance conditions.

In some aspects, the distributed ledger is configured to store hash values of the access event data and the environmental condition data, wherein the underlying data is stored in a separate secure storage system.

In some aspects, the zero-knowledge proof engine is configured to generate cryptographic proofs that verify a sequence of access events occurred in a specified order without revealing timestamps or user identifiers associated with the access events.

### Exemplary Embodiment 7 – DAO Governance System for Security Platform

According to an exemplary embodiment, a security system comprising a decentralized governance system, the system comprises: a plurality of smart lock devices distributed throughout one or more physical facilities, each smart lock device configured to capture access event data and sensor data; a distributed ledger configured to store governance records and voting outcomes; a governance token module configured to issue and manage governance tokens, wherein each governance token represents voting rights within the decentralized governance system; a proposal module configured to receive and store governance proposals submitted by governance token holders, wherein each governance proposal specifies a proposed modification to at least one of platform features or alarm routing protocols; a voting module configured to receive votes from governance token holders on pending governance proposals and record voting outcomes to the distributed ledger; and an execution module configured to implement approved governance proposals based on voting outcomes recorded on the distributed ledger.

In some aspects, the governance proposals comprise proposals for modifications to alarm routing protocols that determine how security alerts are distributed among first responders, facility operators, and emergency services.

In some aspects, the governance token module is configured to distribute governance tokens to stakeholders comprising at least one of schools, first responders, insurers, or facility operators.

In some aspects, the voting module is configured to weight votes based on a quantity of governance tokens held by each voting governance token holder.

In some aspects, the execution module is configured to implement approved modifications to alarm routing protocols by updating configuration parameters of the plurality of smart lock devices via a communications network.

In some aspects, the governance token module is configured to conduct token sales to raise funds for platform development, wherein proceeds from the token sales are managed according to governance proposals approved by governance token holders.

### Exemplary Embodiment 8 – Environmental Monitoring System for Critical Infrastructure

According to an exemplary embodiment, a security system comprising an environmental monitoring system for a sensitive infrastructure facility, the system comprises: a plurality of smart lock devices distributed at secured portals throughout the sensitive infrastructure facility, each smart lock device comprising a locking device and one or more environmental sensors; a plurality of environmental sensors distributed throughout the sensitive infrastructure facility, the plurality of environmental sensors comprising smoke sensors, temperature sensors, and vibration sensors; a sensor data aggregation module configured to receive environmental sensor data from the plurality of smart lock devices and the plurality of environmental sensors; a threshold monitoring module configured to compare the environmental sensor data to configurable threshold values and generate alerts when the environmental sensor data exceeds the configurable threshold values; a blockchain integration module configured to log the environmental sensor data and the alerts to a distributed ledger as immutable records; and a compliance reporting module configured to generate regulatory compliance reports based on the immutable records stored on the distributed ledger.

In some aspects, the compliance reporting module is configured to generate compliance reports for NERC standards for physical security and environmental monitoring at power facilities.

In some aspects, the threshold monitoring module is configured to generate alerts for equipment overheating based on temperature sensor data exceeding a temperature threshold value.

In some aspects, the threshold monitoring module is configured to generate alerts for equipment malfunction based on vibration sensor data exceeding a vibration threshold value.

In some aspects, the system further comprises a digital twin interface configured to display a three-dimensional visualization of the sensitive infrastructure facility with overlays indicating locations and values of environmental sensor readings.

In some aspects, the blockchain integration module is configured to generate zero-knowledge proofs that verify compliance with environmental monitoring conditions without exposing operational data of the sensitive infrastructure facility.

### Exemplary Embodiment 9 – Weapon Chain of Custody Monitoring System

According to an exemplary embodiment, a security system comprising a weapon chain of custody monitoring system for an armory facility, the system comprises: a plurality of smart lock devices positioned at secured portals providing access to weapons storage areas within the armory facility, each smart lock device comprising a camera configured to capture real-time video data, one or more sensors configured to detect access events, and a locking device configured to selectively restrict movement of a door; an edge AI module configured to process the real-time video data to detect individuals and identify objects carried by the individuals, including weapons removed from or returned to the weapons storage areas; a zero-trust access module configured to involve verification of credentials for each access attempt regardless of prior access history; a blockchain integration module configured to log each door open event, each door close event, and each detected weapon movement to a distributed ledger as immutable chain of custody records; and a monitoring interface configured to display real-time status of the weapons storage areas and alert facility personnel when weapon movement is detected outside of authorized access windows.

In some aspects, the chain of custody records comprise an identifier of an individual accessing a weapon, a timestamp of an access event, and a duration of an access period.

In some aspects, the edge AI module is configured to generate alerts when an individual exits a weapons storage area carrying a weapon that was not logged as checked out to the individual.

In some aspects, the system further comprises a digital twin interface configured to provide facility-wide awareness of armory operations via a three-dimensional visualization of the armory facility.

In some aspects, the zero-trust access module is configured to involve multi-factor authentication comprising at least two of a cryptographic token, a biometric verification, or a personal identification number.

In some aspects, the blockchain integration module is configured to operate on a private blockchain within an air-gapped network environment isolated from external networks.

### Exemplary Embodiment 10 – Simulation Environment for Emergency Training

According to an exemplary embodiment, a security system comprising a simulation system for emergency response training, the system comprises: a digital twin interface configured to display an interactive three-dimensional model of a physical facility based on spatial data and real-time video data captured from a plurality of cameras distributed throughout the physical facility; a simulation engine configured to generate simulated threat scenarios within the interactive three-dimensional model, wherein the simulated threat scenarios are overlaid onto the interactive three-dimensional model without affecting physical security systems of the physical facility; a multi-user coordination module configured to enable multiple emergency response personnel to participate simultaneously in training exercises within the interactive three-dimensional model; a scenario recording module configured to record actions taken by the emergency response personnel during the training exercises; and an evaluation module configured to generate performance assessments based on the recorded actions and predefined evaluation criteria.

In some aspects, the simulation engine is configured to generate simulated intruder scenarios comprising a simulated intruder moving through the physical facility along a predefined or dynamically generated path.

In some aspects, the simulation engine is configured to generate simulated disaster scenarios comprising at least one of a fire event, a flood event, or an electromagnetic pulse event, wherein the simulated disaster scenarios model effects on security infrastructure within the physical facility.

In some aspects, the digital twin interface is accessible via at least one of an augmented reality device or a virtual reality device, enabling immersive training experiences for the emergency response personnel.

In some aspects, the multi-user coordination module is configured to assign different roles to the multiple emergency response personnel, wherein each role has different access permissions and responsibilities within the training exercise.

In some aspects, the evaluation module is configured to generate compliance verification reports demonstrating completion of training conditions for regulatory standards.

A number of implementations have been described. Nevertheless, it will be understood that various modifications may be made without departing from the spirit and scope of the disclosure. Accordingly, other implementations are within the scope of the following claims.

1. A system for generating a digital twin environment of a physical facility that enables real-time remote visualization and monitoring of physical security conditions, the system comprising:
a server configured to receive spatial data representing a physical layout of the physical facility and generate an initial three-dimensional spatial model of the physical facility based on the spatial data;
a plurality of cameras distributed throughout the physical facility, each camera configured to capture real-time video data and audio data of a respective area within the physical facility;
a digital twin interface configured to:
receive the initial three-dimensional spatial model;
receive the real-time video data from the plurality of cameras;
stitch the real-time video data from the plurality of cameras together; and
overlay the stitched real-time video data onto the three-dimensional spatial model to generate an interactive digital twin of the physical facility that mirrors real-time activity within the physical facility; and
a user device configured to display the interactive digital twin such that a user may virtually navigate through the physical facility in real-time.

2. The system of claim 1, wherein the digital twin interface is accessible via at least one of an augmented reality device, a virtual reality device, a mobile device, or a desktop computer.

3. The system of claim 1, further comprising a mobile scanning device configured to scan and map the physical facility to generate the spatial data.

4. The system of claim 1, wherein the plurality of cameras are integrated within smart lock devices positioned at secured portals throughout the physical facility.

5. The system of claim 4, wherein each smart lock device comprises:
a camera configured to capture video data and audio data of at least one of an interior area or an exterior area adjacent to a corresponding secured portal;
one or more sensors configured to capture sensor data; and
a locking device configured to selectively restrict movement of a door associated with the corresponding secured portal.

6. The system of claim 5, wherein the one or more sensors include at least one of a motion sensor, a tamper sensor, a smoke sensor, a temperature sensor, an occupancy sensor, or a light detection and ranging sensor.

7. The system of claim 1, wherein the digital twin interface is further configured to overlay sensor event data onto the interactive digital twin, the sensor event data including at least one of intrusion detection data, fire detection data, or access status data.

8. The system of claim 1, further comprising an edge AI module configured to perform object detection and anomaly detection using artificial intelligence on the real-time video data.

9. The system of claim 8, wherein the edge AI module is configured to detect security anomalies including at least one of forced entry, tailgating, unauthorized loitering, or door propping.

10. The system of claim 1, further comprising a blockchain integration module configured to immutably log access events and sensor detections to a distributed ledger.

11. A method for generating a digital twin environment of a physical facility that enables real-time remote visualization and monitoring of physical security conditions, the method comprising:
receiving spatial data representing a physical layout of the physical facility;
generating an initial three-dimensional spatial model of the physical facility based on the spatial data;
installing a plurality of cameras at secured portals distributed throughout the physical facility;
calibrating positions of the plurality of cameras within the three-dimensional spatial model;
capturing real-time video data and audio data from the plurality of cameras;
stitching the real-time video data from the plurality of cameras together;
overlaying the stitched real-time video data onto the three-dimensional spatial model to generate an interactive digital twin of the physical facility; and
enabling real-time virtual navigation through the interactive digital twin via a user interface.

12. The method of claim 11, wherein the plurality of cameras are integrated within smart lock devices positioned at secured portals throughout the physical facility.

13. The method of claim 11, further comprising overlaying sensor data onto the interactive digital twin, the sensor data including at least one of occupancy data, environmental condition data, or access event data.

14. The method of claim 11, further comprising:
detecting an anomaly within the physical facility based on the real-time video data using artificial intelligence; and
generating an alert in response to detecting the anomaly.

15. The method of claim 14, wherein the anomaly includes at least one of forced entry, tailgating, unauthorized loitering, or door propping.

16. The method of claim 11, further comprising logging access events to a distributed ledger via a blockchain integration module.

17. The method of claim 11, wherein receiving the spatial data comprises scanning and mapping the physical facility using a mobile scanning device.

18. A system for generating a digital twin environment for real-time facility monitoring, the system comprising:
a plurality of smart lock devices distributed at secured portals throughout a physical facility, each smart lock device comprising:
a camera configured to capture real-time video data and audio data; and
one or more sensors configured to capture sensor data;
a server linked to the plurality of smart lock devices via a communications network, the server configured to:
receive the real-time video data and the sensor data from the plurality of smart lock devices;
generate a three-dimensional spatial model of the physical facility based at least in part on spatial data representing a physical layout of the physical facility; and
stitch the real-time video data from the plurality of smart lock devices into the three-dimensional spatial model to generate an interactive digital twin; and
a digital twin interface configured to display the interactive digital twin on a user device and to transmit control signals to the plurality of smart lock devices based on user input received via the interactive digital twin, wherein the interactive digital twin enables a user to virtually navigate through the physical facility in real-time by synchronizing physical door states, sensor readings, and video feeds within a unified three-dimensional visualization.

19. The system of claim 18, wherein the digital twin interface is further configured to overlay the sensor data onto the interactive digital twin to display real-time sensor events within the physical facility.

20. The system of claim 18, wherein the server employs artificial intelligence and machine learning to detect a threat within the physical facility based on the real-time video data and the sensor data, and wherein the system is configured to trigger a locking function to simultaneously lock a plurality of locking devices associated with the plurality of smart lock devices in response to detecting the threat.
